(19) United States
(12) Patent Application Publication
(10) Pub. No.: US 2010/0196104 A1
(43) Pub. Date: Aug. 5, 2010

(54) CO2 SEQUESTERING SOIL STABILIZATION COMPOSITION

(76) Inventors: Brent R. Constantz, Portola Valley, CA (US); Andrew Youngs, Los Gatos, CA (US)

Correspondence Address: Calera Corporation;Eric Witt, 14600 Winchester Blvd., Los Gatos, CA, 95032, US

(21) Appl. No.: 12/698,992

(22) Filed: Feb. 2, 2010

Related U.S. Application Data
(60) Provisional application No. 61/149,633, filed on Feb. 3, 2009.
(60) Provisional application No. 61/181,250, filed on May 26, 2009.
(60) Provisional application No. 61/219,310, filed on Jun. 22, 2009.

(51) Int. Cl. C09K 17/02; C09K 17/10; C04B 28/04; E02D 3/00

(52) U.S. Cl. 405/302.4; 502/400; 106/638; 106/713

(57) ABSTRACT

CO₂ sequestering soil stabilization compositions are provided. The soil stabilization compositions of the invention include a CO₂ sequestering component, e.g., a CO₂ sequestering carbonate composition. Additional aspects of the invention include methods of making and using the CO₂ sequestering soil stabilization composition. The invention also comprises the method of stabilizing soil and producing a soil stabilized structure utilizing such compositions.

### CROSS-REFERENCE

This application claims the benefit of U.S. Provisional Application No. 61/149,633, titled, “CO₂ Sequestering Soil Stabilization Composition,” filed 3 Feb. 2009; U.S. Provisional Application No. 61/181,250, titled, “Compositions and Methods Using Substances with Negative δ¹³C Values,” filed 26 May 2009; and U.S. Provisional Application No. 61/219,310, titled, “Compositions and Methods Using Substances with Negative δ¹³C Values,” filed 22 Jun. 2009, which applications are incorporated herein by reference.

### BACKGROUND OF THE INVENTION

Construction and maintenance of roads, building foundations and pavements require a solid, stabilized base. Paving a surface often requires the use of chemical stabilizers which impart mechanical strength to the soil beneath in order to improve the stability of the soil. These improvements can increase the longevity of the paved surface, resistance to erosion and decrease the frequency of repair.

Many soil stabilization compositions employed today are based upon the use of Portland cement as the main stabilizing constituent. Portland cement is made primarily from limestone, certain clay minerals, and gypsum, in a high temperature process that drives off carbon dioxide and chemically combines the primary ingredients into new compounds. Because carbon dioxide is generated by both the cement production process itself, as well as by energy plants that generate power to run the production process, cement production is currently a leading source of current carbon dioxide atmospheric emissions. It is estimated that cement plants account for 5% of global emissions of carbon dioxide. As global warming and ocean acidification become an increasing problem and the desire to reduce carbon dioxide gas emissions (a principal cause of global warming) continues, the cement production industry will fall under increased scrutiny.

Carbon dioxide (CO₂) emissions have been identified as a major contributor to the phenomenon of global warming and ocean acidification. CO₂ is a by-product of combustion and it creates operational, economic, and environmental problems. It is expected that elevated atmospheric concentrations of CO₂ and other greenhouse gases will facilitate greater storage of heat within the atmosphere leading to enhanced surface temperatures and rapid climate change. CO₂ has also been interacting with the oceans driving down the pH toward 8.0. CO₂ monitoring has shown atmospheric CO₂ has risen from approximately 280 ppm in the 1950s to approximately 380 pmm today, and is expect to exceed 400 ppm in the next decade. The impact of climate change will likely be economically expensive and environmentally hazardous. Reducing potential risks of climate change will require sequestration of atmospheric CO₂.

### SUMMARY OF THE INVENTION

CO₂ sequestering soil stabilization compositions are provided. The soil stabilization compositions of the invention include a CO₂ sequestering component, e.g., a CO₂ sequestering carbonate composition. Additional aspects of the invention include methods of making and using the CO₂ sequestering soil stabilization composition. The invention also comprises the method of stabilizing soil and producing a soil stabilized structure utilizing such composition.

In some embodiments, the invention provides a soil stabilization composition that includes a carbon dioxide (CO₂) sequestering component. In some embodiments, the CO₂ sequestering component includes a carbonate compound composition, a bicarbonate compound composition, or any combination thereof. In some embodiments, the CO₂ sequestering component includes a metal carbonate compound composition, a metal bicarbonate compound composition, or any combination thereof. In some embodiments, the carbonate compound composition includes calcium carbonate, magnesium carbonate, calcium magnesium carbonate, or any combination thereof. In some embodiments, the carbonate compound composition includes amorphous calcium carbonate, vaterite, aragonite, calcite, nesquehonite, hydromagnesite, amorphous magnesium carbonate, anhydrous magnesium carbonate, dolomite, protodolomite, or any combination thereof. In some embodiments, the carbonate compound composition, bicarbonate compound composition, or combination thereof includes a precipitate from an alkaline-earth metal containing water. In some embodiments, the alkaline-earth metal-containing water includes CO₂ derived from an industrial waste stream. In some embodiments, the industrial waste stream includes flue gas from the combustion of fossil fuel. In some embodiments, the CO₂ sequestering component has a δ¹³C value of less than −5‰. In some embodiments, the carbonate compound composition, bicarbonate compound composition, or combination thereof includes a precipitate from an alkaline-earth metal containing water, wherein the alkaline-earth metal containing water includes a CO₂ charged solution. In some embodiments, the CO₂ charged solution includes CO₂ derived from an industrial waste stream and a contacting solution. In some embodiments, the industrial waste stream used to charge the CO₂ charged solution includes flue gas from the combustion of fossil fuel. In some embodiments, the contacting solution includes NaOH, KOH, an alkaline brine, a clear liquid, or any combination thereof. In some embodiments, in which the CO₂ sequestering component includes a precipitate from an alkaline-earth metal containing water that includes a CO₂ charged solution, the CO₂ sequestering component has a δ¹³C value of less than −5‰. In some embodiments, the soil stabilization composition further includes at least one of: water, a cementitious component, a metal cation, and a metal silicate. In some embodiments, the cementitious component is portland cement. In some embodiments, the cementitious component is a CO₂ sequestering cement. In some embodiments, the metal cation is sulfur, silicon, strontium, boron, sodium, potassium, lanthium, zinc, iron, or any combination thereof. In some embodiments, the metal silicate is magnesium silicate, calcium silicate, aluminum silicate, or any combination thereof. In some embodiments, the CO₂ sequestering component renders the soil stabilization composition reduced in carbon footprint, carbon neutral or carbon negative.

In some embodiments, the invention provides a method of soil stabilization that includes obtaining a soil stabilization composition that includes a carbon dioxide (CO₂) sequestering component, contacting the soil stabilization composition with soil, and allowing the stabilization composition-contacted soil to set into a solid product. In some embodiments, the method of soil stabilization further includes compacting the stabilization composition-contacted soil. In some embodiments, the contacting step further includes mixing the soil stabilization composition with the soil. In some embodiments, the mixing includes mechanically mixing the soil stabilization composition with soil in the ground. In some embodiments, the mixing includes removing the soil from the ground and mixing the soil stabilization composition with the soil in an external mixer and returning the mixture back to the ground. In some embodiments, the external mixer is a rotary mixer or a road reclaimer. In some embodiments, the soil stabilization composition is a slurry, a solid, or a paste. In some embodiments, the contacting step includes spraying, pouring, or spraying and pouring the soil stabilization composition onto the soil. In some embodiments, the contacting step includes releasing the soil stabilization composition at a depth within the soil. In some embodiments, the allowing step further includes producing a formed structure from the soil stabilization composition-contacted soil. In some embodiments, producing the formed structure includes compacting the soil stabilization composition and soil mixture. In some embodiments, producing the formed structure includes shaping the soil stabilization-contacted soil. In some embodiments, producing the formed structure includes placing the soil stabilization-contacted soil into a mold to produce a formed structure. In some embodiments, the method is a full-depth reclamation.

In some embodiments, the invention provides a soil stabilized structure that includes soil and a soil stabilization composition that includes a carbon dioxide (CO₂) sequestering component. In some embodiments, the invention provides a soil stabilized structure that includes soil and a soil stabilization composition that includes a CO₂ sequestering component is previously described herein. In some embodiments, the soil stabilized structure is a brick, a block, a paving brick, a landfill, a compost pad, a road, a building base, a basin, a conduit, or other structural component. In some embodiments, the conduit is a channel, an irrigation canal lining, or a pipe lining.

In some embodiments, the invention provides a method of producing a soil stabilization composition that includes obtaining a carbon dioxide (CO₂) sequestering component and producing a soil stabilization composition that includes the carbon dioxide (CO₂) sequestering component. In some embodiments, the CO₂ sequestering component includes a carbonate compound composition, a bicarbonate compound composition, or a combination thereof. In some embodiments, obtaining the CO₂ sequestering component includes subjecting an alkaline-earth metal containing water to carbonate and/or bicarbonate precipitation conditions. In some embodiments, the alkaline-earth metal containing water includes CO₂ charged solution. In some embodiments, the CO₂ charged solution includes CO₂ derived from an industrial waste stream and a contacting solution. In some embodiments, the CO₂ sequestering component is a cementitious component. In some embodiments, the CO₂ sequestering component has a δ¹³C value of less than −5.00‰. In some embodiments, producing a soil stabilization product includes mixing the CO₂ sequestering component with portland cement, supplementary cementitious material, aggregate, crushed limestone, calcium oxide, calcium hydroxide, natural pozzolans, calcined pozzolans, asphalt emulsion, organic polymeric material, or any combination thereof.

In some embodiments, the invention provides a method of sequestering carbon dioxide that includes precipitating a CO₂ sequestering carbonate compound composition from an alkaline-earth-metal-containing-water and producing a soil stabilization composition that includes the CO₂ sequestering carbonate compound composition. In some embodiments, the alkaline-earth-metal-containing water is contacted to an industrial waste stream prior to the precipitating step.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 provides a schematic of a CO₂ sequestering component production process according to an embodiment of the invention.

### DETAILED DESCRIPTION OF THE INVENTION

CO₂ sequestering soil stabilization compositions are provided. The soil stabilization compositions of the invention include a CO₂ sequestering component, e.g., a CO₂ sequestering carbonate composition. Additional aspects of the invention include methods of making and using the CO₂ sequestering soil stabilization composition. The invention also comprises the method of stabilizing soil and producing a soil stabilized structure utilizing such composition.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a,” “an,” and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

In further describing the subject invention, embodiments of the CO₂ sequestering soil stabilization composition, as well as methods for its production, will be described first in greater detail. Next, examples of methods of using the CO₂ sequestering soil stabilization composition and the production of a stabilized soil structure will be reviewed further.

### CO₂ Sequestering Soil Stabilization Composition

CO₂ sequestering soil stabilization compositions are provided by the invention. By “CO₂ sequestering soil stabilization composition” is meant that the soil stabilization composition contains carbon derived from a fuel used by humans, e.g., carbon having a fossil fuel origin. For example, CO₂ sequestering soil stabilization compositions according to aspects of the present invention contain carbon that was released in the form of CO₂ from the combustion of fuel. In certain embodiments, the carbon sequestered in a CO₂ sequestering soil stabilization composition is in the form of a carbonate compound, a bicarbonate compound, or a combination thereof. Therefore, in certain embodiments, CO₂ sequestering soil stabilization compositions according to aspects of the subject invention contain carbonate compounds or bicarbonate compounds or a combination of both where at least part of the carbon in the compounds is derived from a fuel used by humans, e.g., a fossil fuel. As such, production of soil stabilization compositions of the invention results in the placement of CO₂ into a storage stable form, e.g., a component of a soil stabilized structure, i.e., a man-made structure, such as a soil stabilized road, landfill etc. As such, production of the CO₂ sequestering soil stabilized compositions of the invention results in the prevention of CO₂ gas from entering the atmosphere. The soil stabilization compositions of the invention provide for long term storage of CO₂ in a manner such that CO₂ is sequestered (i.e., fixed) in the soil stabilized structure, where the sequestered CO₂ does not become part of the atmosphere. By “long term storage” is meant that the soil stabilized structure provided by the invention keeps its sequestered CO₂ fixed for extended periods of time (when the soil stabilized structure is maintained under conditions conventional for its intended use) without significant, if any, release of the CO₂. Extended periods of time in the context of the invention may be 1 year or longer, 5 years or longer, 10 years or longer, 25 years or longer, 50 years or longer, 100 years or longer, 250 years or longer, 1000 years or longer, 10,000 years or longer, 1,000,000 years or longer, or even 100,000,000 years or longer. With respect to the CO₂ sequestering soil stabilization compositions, when they are employed in their intended use and over their lifetime, the amount of degradation, if any, as measured in terms of CO₂ gas release from the product will not exceed 5%/year, and in certain embodiments will not exceed 1%/year.

Embodiments of methods of the invention are negative carbon footprint methods. By “negative carbon footprint” is meant that the amount by weight of CO₂ that is sequestered (e.g., through conversion of CO₂ to carbonate, bicarbonate or both carbonate and bicarbonate) by practice of the methods is greater that the amount of CO₂ that is generated (e.g., through power production, base production, etc) to practice the methods. In some instances, the amount by weight of CO₂ that is sequestered by practicing the methods exceeds the amount by weight of CO₂ that is generated in practicing the methods by 1 to 100%, such as 5 to 100%, including 10 to 95%, 10 to 90%, 10 to 80%, 10 to 70%, 10 to 60%, 10 to 50%, 10 to 40%, 10 to 30%, 10 to 20%, 20 to 95%, 20 to 90%, 20 to 80%, 20 to 70%, 20 to 60%, 20 to 50%, 20 to 40%, 20 to 30%, 30 to 95%, 30 to 90%, 30 to 80%, 30 to 70%, 30 to 60%, 30 to 50%, 30 to 40%, 40 to 95%, 40 to 90%, 40 to 80%, 40 to 70%, 40 to 60%, 40 to 50%, 50 to 95%, 50 to 90%, 50 to 80%, 50 to 70%, 50 to 60%, 60 to 95%, 60 to 90%, 60 to 80%, 60 to 70%, 70 to 95%, 70 to 90%, 70 to 80%, 80 to 95%, 80 to 90%, and 90 to 95%. In some instances, the amount by weight of CO₂ that is sequestered by practicing the methods exceeds the amount by weight of CO₂ that is generated in practicing the methods by 5% or more, by 10% or more, by 15% or more, by 20% or more, by 30% or more, by 40% or more, by 50% or more, by 60% or more, by 70% or more, by 80% or more, by 90% or more, by 95% or more.

Soil stabilization compositions of the invention include a CO₂ sequestering component. CO₂ sequestering components are components that store a significant amount of CO₂ in a storage-stable format, such that CO₂ gas is not readily produced from the product and released into the atmosphere. In certain embodiments, the CO₂ sequestering product can store about 50 tons or more of CO₂, such as about 100 tons or more of CO₂, including 150 tons or more of CO₂, for instance about 200 tons or more of CO₂, such as about 250 tons or more of CO₂, including about 300 tons or more of CO₂, such as about 350 tons or more of CO₂, including 400 tons or more of CO₂, for instance about 450 tons or more of CO₂, such as about 500 tons or more of CO₂, including about 550 tons or more of CO₂, such as about 600 tons or more of CO₂, including 650 tons or more of CO₂, for instance about 700 tons or more of CO₂, for every 1000 tons of CO₂ sequestering product, e.g., a material to be used in the built environment such as cement or aggregate, produced. Thus, in certain embodiments, the CO₂ sequestering product comprises about 5% or more of CO₂, such as about 10% or more of CO₂, including about 25% or more of CO₂, for instance about 50% or more of CO₂, such as about 75% or more of CO₂, including about 90% or more of CO₂.

In certain embodiments the soil stabilization compositions of the invention will contain carbon from fossil fuel (i.e. within the CO₂ sequestering component); because of its fossil fuel origin, the relative carbon isotopic composition (δ¹³C) value of such soil stabilization composition will be different from that of other materials used for soil stabilization, e.g., limestone. As is known in the art, the plants from which fossil fuels are derived preferentially utilize ¹²C over ¹³C, thus fractionating the carbon isotopes so that the value of their ratio differs from that in the atmosphere in general; this value, when compared to a standard value (PeeDee Belemnite, or PDB, standard), is termed the relative carbon isotopic composition (δ¹³C) value. δ¹³C values for coal are generally in the range −30 to −20‰ and δ¹³C values for methane may be as low as −20‰ to −40‰ or even −40‰ to −80‰. δ¹³C values for atmospheric CO₂ are −10‰ to −7‰, for limestone aggregate +3‰ to −3‰, and for marine bicarbonate, 0‰. Even if the soil stabilization composition contains some natural limestone, or other source of C with a less negative δ¹³C value than fossil fuel, its δ¹³C value generally will still be negative and less than values for limestone or atmospheric CO₂. Soil stabilization composition of the invention thus include soil stabilization compositions with a CO₂ sequestering component with a δ¹³C less than (more negative than)-10‰, such as less than (more negative than)-12‰, −14‰, −16‰, −18‰, −20‰, −22‰, −24‰, −26‰, −28‰, or less than (more negative than) −30‰. In some embodiments the invention provides a soil stabilization composition with a δ¹³C less than (more negative than) −10‰. In some embodiments the invention provides a soil stabilization composition with a CO₂ sequestering component with a δ¹³C less than (more negative than) −14‰. In some embodiments the invention provides a soil stabilization composition with a CO₂ sequestering component with a δ¹³C less than (more negative than)-18‰. In some embodiments the invention provides a soil stabilization composition with a CO₂ sequestering component with a δ¹³C less than (more negative than)-20‰. In some embodiments the invention provides a soil stabilization composition with a CO₂ sequestering component with a δ¹³C less than (more negative than) −24‰. In some embodiments the invention provides a soil stabilization composition with a CO₂ sequestering component with a δ¹³C less than (more negative than) −28‰. In some embodiments the invention provides a soil stabilization composition with a CO₂ sequestering component with a δ¹³C less than (more negative than) −30‰. In some embodiments the invention provides a soil stabilization composition with a CO₂ sequestering component with a δ¹³C less than (more negative than) −32‰. In some embodiments the invention provides a soil stabilization composition with a CO₂ sequestering component with a δ¹³C less than (more negative than) −34‰, Such soil stabilization compositions with a CO₂ sequestering component may be carbonate and/or bicarbonate-containing soil stabilization composition as herein, e.g., a soil stabilization composition that contains at least 10, 20, 30, 40, 50, 60, 70, 80, or 90% carbonate and/or bicarbonate, e.g., at least 50% carbonate and/or bicarbonate by weight.

The relative carbon isotope composition (δ¹³C) value with units of ‰ (per mil) is a measure of the ratio of the concentration of two stable isotopes of carbon, namely ¹²C and ¹³C, relative to a standard of fossilized belemnite (the PDB standard).

δ¹³C‰=[(¹³C/¹²Cₛₐₘₚₗₑ−¹³C/¹²C_{PDB standard})/(¹³C/¹²C_{PDB standard})]×1000

¹²C is preferentially taken up by plants during photosynthesis and in other biological processes that use inorganic carbon because of its lower mass. The lower mass of ¹²C allows for kinetically limited reactions to proceed more efficiently than with ¹³C. Thus, materials that are derived from plant material, e.g., fossil fuels, have relative carbon isotope composition values that are less than those derived from inorganic sources. The carbon dioxide in flue gas produced from burning fossil fuels reflects the relative carbon isotope composition values of the organic material that was fossilized. Table 1 lists relative carbon isotope composition value ranges for relevant carbon sources for comparison.

Material incorporating carbon from burning fossil fuels reflects δ¹³C values that are more like those of plant derived material, i.e. less, than that which incorporates carbon from atmospheric or non-plant marine sources. Verification that the material produced by a carbon dioxide sequestering process is composed of carbon from burning fossil fuels can include measuring the δ¹³C value of the resultant material and confirming that it is not similar to the values for atmospheric carbon dioxide, nor marine sources of carbon.

TABLE 1
Relative carbon isotope composition (δ¹³C) values
for carbon sources of interest.

| Carbon Source | δ¹³C Range [‰] | δ¹³C Average value [‰] |
|---|---|---|
| C3 Plants (most higher | −23 to −33 | −27 |
| plants) | | |
| C4 Plants (most tropical | −9 to −16 | −13 |
| and marsh plants) | | |
| Atmosphere | −6 to −7 | −6 |
| Marine Carbonate (CO₃) | −2 to +2 | 0 |
| Marine Bicarbonate | −3 to +1 | −1 |
| (HCO₃) | | |
| Coal from Yallourn | −27.1 to −23.2 | −25.5 |
| Seam in Australia¹ | | |
| Coal from Dean Coal | −24.47 to −25.14 | −24.805 |
| Bed in Kentucky, USA² | | |

¹Holdgate, G. R. et al., Global and Planetary Change, 65 (2009) pp. 89-103.
²Elswick, E. R. et al., Applied Geochemistry, 22 (2007) pp. 2065-2077.

In some embodiments the invention provides a method of characterizing a composition comprising measuring its relative carbon isotope composition (δ¹³C) value. In some embodiments the composition is a composition that contains carbonates, e.g., magnesium and/or calcium carbonates. In some embodiments the composition is a composition that contains bicarbonates, e.g., magnesium and/or calcium bicarbonates or metal bicarbonates. Any suitable method may be used for measuring the δ¹³C value, such as mass spectrometry or off-axis integrated-cavity output spectroscopy (off-axis ICOS).

One difference between the carbon isotopes is in their mass. Any mass-discerning technique sensitive enough to measure the amounts of carbon we have can be used to find ratios of the ¹³C to ¹²C isotope concentrations. Mass spectrometry is commonly used to find δ¹³C values. Commercially available are bench-top off-axis integrated-cavity output spectroscopy (off-axis ICOS) instruments that are able to determine δ¹³C values as well. These values are obtained by the differences in the energies in the carbon-oxygen double bonds made by the ¹²C and ¹³C isotopes in carbon dioxide. The δ¹³C value of a precipitate containing carbonates and/or bicarbonates that results from a carbon sequestration process serves as a fingerprint for a CO₂ gas source, as the value will vary from source to source, but in most carbon sequestration cases δ¹³C will generally be in a range of −9‰ to −35‰.

In some embodiments the methods further include the measurement of the amount of carbon in the composition. Any suitable technique for the measurement of carbon may be used, such as coulometry.

Precipitation material, which comprises one or more synthetic carbonates, bicarbonates, or a mixture of carbonates and bicarbonates derived from industrial CO₂, reflects the relative carbon isotope composition (δ¹³C) of the fossil fuel (e.g., coal, oil, natural gas, or flue gas) from which the industrial CO₂ (from combustion of the fossil fuel) was derived. The relative carbon isotope composition (δ¹³C) value with units of ‰ (per mile) is a measure of the ratio of the concentration of two stable isotopes of carbon, namely ¹²C and ¹³C, relative to a standard of fossilized belemnite (the PDB standard).

As such, the δ¹³C value of the CO₂ sequestering component (i.e. synthetic carbonate and/or bicarbonate-containing precipitation material) serves as a fingerprint for a CO₂ gas source used to form the precipitate. The δ¹³C value may vary from source to source (i.e., fossil fuel source), but the δ¹³C value for CO₂ sequestering component of the composition of the invention generally, but not necessarily, ranges between −9‰ to −35‰. In some embodiments, the δ¹³C value for the synthetic carbonate and/or bicarbonate-containing precipitation material (i.e. CO₂ sequestering component) is between −1‰ and −50‰, between −5‰ and −40‰, between −5‰ and −35‰, between −7‰ and −40‰, between −7‰ and −35‰, between −9‰ and −40‰, or between −9‰ and −35‰. In some embodiments, the δ¹³C value for the synthetic carbonate-containing precipitation material (i.e. CO₂ sequestering component) is less than (i.e., more negative than)-3‰, −5‰, −6‰, −7‰, −8‰, −9‰, −10‰, −11‰, −12‰, −13‰, −14‰, −15‰, −16‰, −17‰, −18‰, −19‰, −20‰, −21‰, −22‰, −23‰, −24‰, −25‰, −26‰, −27‰, −28‰, −29‰, −30‰, −31‰, −32‰, −33‰, −34‰, −35‰, −36‰, −37‰, −38‰, −39‰, −40‰, −41‰, −42‰, −43‰, −44‰, or −45‰, wherein the more negative the δ¹³C value, the more rich the synthetic carbonate-containing composition is in ¹²C. Any suitable method may be used for measuring the δ¹³C value, methods including, but no limited to, mass spectrometry or off-axis integrated-cavity output spectroscopy (off-axis ICOS).

Storage stable CO₂ sequestering products produced by methods of the invention may include carbonate compounds, bicarbonate compounds or a mixture thereof that, upon combination with fresh water, dissolve and produce different minerals that are more stable in fresh water than compounds of the initial precipitate product composition. (Although the compounds of the initial precipitate product composition may dissolve upon combination with freshwater and then produce different components, CO₂ gas is not liberated in significant amounts, or in some cases at all, in any such reaction). The compounds of the initial precipitate product composition may be ones that are more stable in salt water than they are in freshwater, such that they may be viewed as saltwater metastable compounds. The amount of carbonate in the product, as determined by coulometry using the protocol described in coulemetric titration, is 40% or higher, such as 70% or higher, including 80% or higher.

The storage stable precipitated product may include one or more different carbonate compounds, such as two or more different carbonate compounds, e.g., three or more different carbonate compounds, five or more different carbonate compounds, etc., including non-distinct, amorphous carbonate compounds. Carbonate compounds of precipitated products of the invention may be compounds having a molecular formulation Xₘ(CO₃)ₙ where X is any element or combination of elements that can chemically bond with a carbonate group or its multiple, wherein X is in certain embodiments an alkaline earth metal (elements found in column IIA of the periodic table of elements) and not an alkali metal (elements found in column IA of the periodic table of elements); wherein m and n are stoichiometric positive integers. These carbonate compounds may have a molecular formula of Xₘ(CO₃)ₙ.H₂O, where there are one or more structural waters in the molecular formula.

The carbonate compounds may be amorphous or crystalline. The particular mineral profile, i.e., the identity of the different types of different carbonate minerals and the amounts of each, in the carbonate compound composition may vary and will be dependent on the particular nature of the water source from which it is derived, as well as the particular conditions employed to derive it.

As indicated above, in some embodiments of the invention, the carbonate compounds of the compositions are metastable carbonate compounds that are more stable in saltwater than in freshwater, such that upon contact with fresh water of any pH they dissolve and reprecipitate into other fresh water stable minerals. In certain embodiments, the carbonate compounds are present as small particles, e.g., with particle sizes ranging from 0.1 microns to 100 microns, e.g., 1 to 100 microns, or 10 to 100 microns, or 50 to 100 microns, in some embodiments 0.5 to 10 microns, as determined by Scanning electron microscopy. In some embodiments, the particle sizes exhibit a bimodal or multi-modal distribution. In certain embodiments, the particles have a high surface are, e.g., ranging from 0.5 to 100 m²/gm, 0.5 to 50 m²/gm, such as from 0.5 to 2.0 m²/gm, as determined by Brauner, Emmit, & Teller (BET) Surface Area Analysis. In some embodiments, the CO₂ sequestering products produced by methods of the invention may include rod-shaped crystals and amorphous solids. The rod-shaped crystals may vary in structure, and in certain embodiments have length to diameter ratio ranging from 500 to 1, such as 10 to 1. In certain embodiments, the length of the crystals ranges from 0.5 μm to 500 μm, such as from 5 μm to 100 μm. In yet other embodiments, substantially amorphous solids are produced.

The carbonate compounds of the precipitated products may include a number of different cations, such as but not limited to: calcium, magnesium, sodium, potassium, sulfur, boron, silicon, strontium, and combinations thereof. Of interest are carbonate compounds of divalent metal cations, such as calcium and magnesium carbonate compounds. Specific carbonate compounds of interest include, but are not limited to: calcium carbonate minerals, magnesium carbonate minerals and calcium magnesium carbonate minerals. Calcium carbonate minerals of interest include, but are not limited to: calcite (CaCO₃), aragonite (Ca CO₃), vaterite (Ca CO₃), ikaite (Ca CO₃.6H₂O), and amorphous calcium carbonate (CaCO₃.nH₂O). Magnesium carbonate minerals of interest include, but are not limited to magnesite (Mg CO₃), barringtonite (Mg CO₃.2H₂O), nesquehonite (Mg CO₃.3H₂O), lanfordite (Mg CO₃.5H₂O), hydromagnesite, and amorphous magnesium carbonate (MgCO₃.nH₂O). Calcium magnesium carbonate minerals of interest include, but are not limited to dolomite (CaMg (CO₃)₂), huntite (Ca₁Mg₃ (CO₃)₄) and sergeevite (Ca₂Mg₁₁(CO₃)₁₃.10H₂O). The carbonate compounds of the product may include one or more waters of hydration, or may be anhydrous.

In some instances, the amount by weight of magnesium carbonate compounds in the precipitate exceeds the amount by weight of calcium carbonate compounds in the precipitate. For example, the amount by weight of magnesium carbonate compounds in the precipitate may exceed the amount by weight calcium carbonate compounds in the precipitate by 5% or more, such as 10% or more, 15% or more, 20% or more, 25% or more, 30% or more. In some instances, the weight ratio of magnesium carbonate compounds to calcium carbonate compounds in the precipitate ranges from 1.5-5 to 1, such as 2-4 to 1 including 2-3 to 1.

In some embodiments, the precipitated products of the invention may include bicarbonate compounds. Bicarbonates of the invention of interest include, but are not limited to: sodium bicarbonate, calcium bicarbonates, hydrated calcium bicarbonates, magnesium bicarbonates, hydrated magnesium bicarbonates, and bicarbonates of other metals (e.g. strontium, iron, potassium). The bicarbonate compounds of the product may include one or more waters of hydration, or may be anhydrous. The bicarbonate compounds of the product may be amorphous or crystalline.

In some instances, the precipitated product may include hydroxides, such as divalent metal ion hydroxides, e.g., calcium and/or magnesium hydroxides. The principal calcium hydroxide mineral of interest is portlandite Ca(OH)₂, and amorphous hydrated analogs thereof. The principal magnesium hydroxide mineral of interest is brucite Mg(OH)₂, and amorphous hydrated analogs thereof.

The CO₂ sequestering components of the invention are derived from, e.g., precipitated from water. As the CO₂ sequestering component of the soil stabilization composition are precipitated from water, they will include one or more components that are present in the water source from which they are precipitated and identify the compositions that come from the water source, where these identifying components and the amounts thereof are collectively referred to herein as a water source identifier. For example, if the water source is sea water, identifying compounds that may be present in carbonate and/or bicarbonate compound compositions include, but are not limited to: chloride, sodium, sulfur, potassium, bromide, silicon, strontium and the like. Any such source-identifying or “marker” elements are generally present in small amounts, e.g., in amounts of 20,000 ppm or less, such as amounts of 2000 ppm or less. In certain embodiments, the “marker” compound is strontium, which may be present in the precipitate incorporated into the aragonite lattice, and make up 3 ppm or more, ranging in certain embodiments from 3 to 10,000 ppm, such as from 5 to 5000 ppm, including 5 to 1000 ppm, e.g., 5 to 500 ppm, including 5 to 100 ppm. In some embodiments, strontium may be present in the precipitate in a carbonate and/or bicarbonate compound, and make up 3 ppm or more, in certain embodiments 100 ppm or more, such as 150 ppm or more, including 200 to 10,000 ppm, e.g., 300 to 9,000 ppm, including 1,500 to 8,000 ppm. Another “marker” compound of interest is magnesium, which may be present in amounts of up to 20% mole substitution for calcium in carbonate compounds. The water source identifier of the compositions may vary depending on the particular water source, e.g., saltwater employed to produce the water-derived carbonate composition. In certain embodiments, the calcium carbonate content of the precipitate is 25% w/w or higher, In certain embodiments, the carbonate composition is characterized by having a water source identifying carbonate to hydroxide compound ratio, where in certain embodiments this ratio ranges from 100 to 1, such as 10 to 1 and including 1 to 1.

The term “soil” is used in its conventional sense to refer to all of the types of natural media for the growth of land plants. It may also refer to all of the unconsolidated materials above bedrock and may include a mixture of clay, silt, gravel and sand. By “clay” is meant a group of finely crystalline, metacolloidal or amorphous hydrous silicates composed essentially of aluminium, magnesium and iron. Clay particles may form a plastic, mouldable mass when finely ground and mixed with water and retains its shape on drying, becoming firm, rigid and permanently hard on heating.

There are many different types of soils, each containing varying percentages of clay. However, soils which may be used in relation to construction of structures using the CO₂ sequestering soil stabilization compositions of the invention usually contain from 0.5-20% of clay. When soils contain higher percentages of clay e.g. black soil, such soil is usually not appropriate for forming structures.

### Preparation of CO₂ Sequestering Soil Stabilization Compositions

Aspects of the invention also include methods of preparing CO₂ sequestering soil stabilization compositions. CO₂ sequestering soil stabilization compositions may be prepared by producing a CO₂ sequestering component and then preparing the soil stabilization composition using the CO₂ sequestering component. Each of these aspects of the invention will now be described in greater detail.

A variety of different methods may be employed to prepare the CO₂ sequestration component of the soil stabilization composition of the invention. CO₂ sequestration protocols of interest include, but are not limited to, those disclosed in U.S. patent application Ser. Nos. 12/126,776 publication number US 2009-0020044 A1, titled,” Hydraulic cements comprising carbonate compound compositions”, filed 23 May 2008; 12/163,205 publication number US 2009-0001020 A1, titled, “DESALINATION METHODS AND SYSTEMS THAT INCLUDE CARBONATE COMPOUND PRECIPITATION”, filed 27 Jun. 2008; 12/344,019 publication number US 2009-0169452 A1; 12/475,378, titled, “ROCKS AND AGGREGATE, AND METHODS OF MAKING AND USING THE SAME”, filed 29 May 2009; 12/486,692 publication number US 2010-0000444 A1, titled, “METHODS AND SYSTEMS FOR UTILIZING WASTE SOURCES OF METAL OXIDES” filed 17 Jun. 2009; 12/501,217 publication number US 2009-0301352 A1, titled, “PRODUCTION OF CARBONATE-CONTAINING COMPOSITIONS FROM MATERIAL COMPRISING METAL SILICATES” filed 10 Jul. 2009; 12/557,492, titled “CO2 COMMODITY TRADING SYSTEM AND METHOD,” filed 10 Sep. 2009, as well as pending U.S. Provisional Patent Application Ser. Nos. 61/017,405, titled, “METHODS OF SEQUESTERING CO2,” filed 28 Dec. 2007; 61/017,419, titled, “PORTLAND CEMENT BLENDS COMPRISING SALT WATER-DERIVED MINERAL COMPOSITIONS,” filed 28 Dec. 2007; 61/057,173, titled, “SEQUESTERING POWER PLANT GENERATED CO2,” filed 29 may 2008; 61/056,972, titled,” CO2 SEQUESTERING AGGREGATE, AND METHODS OF MAKING AND USING THE SAME,” filed 29 May 2008; 61/073,319, titled, “METHODS OF SEQUESTERING CO2 UTILIZING ASH,” filed, 17 Jun. 2008; 61/079,790, titled, “Use of Silicon Containing Minerals to Produce Cements Including Pozzolans,” filed 10 Jul. 2008; 61/081,299 titled, “LOW ENERGY pH MODULATION FOR CARBON SEQUESTRATION USING HYDROGEN ABSORPTIVE METAL CATALYSTS,” filed 16 Jul. 2008; 61/082,766, title, “CO2 SEQUESTRATION BY CARBONATE COMPOUND PRODUCTION,” filed 22 Jul. 2008; 61/088,347, titled, “HIGH YIELD CO2 SEQUESTRATION PRODUCT PRODUCTION,” filed 13 Aug. 2008; 61/088,340, titled, “MEANS FOR REDUCING CO2 EMISSIONS IN PORTLAND CEMENT PRODUCTION,” filed 12 Aug. 2008; 61/101,629, title, “METHODS OF PRODUCING CARBON SEQUESTRATION TRADABLE COMMODITIES, AND SYSTEMS FOR TRANSFERRING THE SAME,” filed 30 Sep. 2008; and 61/101,631, titled, “CO2 SEQUESTRATION,” filed 30 Sep. 2008; the disclosures of which are herein incorporated by reference.

CO₂ sequestering components of the invention include carbonate compositions, bicarbonate compositions, or combinations thereof that may be produced by precipitating a metal carbonate and/or bicarbonate composition from a water, such as calcium and/or magnesium carbonate and/or bicarbonate composition. The carbonate, bicarbonate or carbonate and bicarbonate compound compositions that make up the CO₂ sequestering components of the invention include metastable carbonate and/or bicarbonate compounds that may be precipitated from water, such as a salt-water, as described in greater detail below. The carbonate and/or bicarbonate compound compositions of the invention include precipitated crystalline and/or amorphous carbonate compounds, bicarbonate compounds, or mixtures thereof.

In certain embodiments, the water from which the carbonate and/or bicarbonate precipitates are produced is a saltwater. In such embodiments, the carbonate and/or bicarbonate compound composition may be viewed as a saltwater derived carbonate and/or bicarbonate compound composition. As used herein, “saltwater-derived carbonate and/or bicarbonate compound composition” means a composition derived from saltwater and made up of one or more different carbonate and/or bicarbonate crystalline and/or amorphous compounds with or without one or more hydroxide crystalline or amorphous compounds. The term “saltwater” is employed in its conventional sense to refer to a number of different types of aqueous liquids other than fresh water, where the term “saltwater” includes brackish water, sea water and brine (including man-made brines, e.g., geothermal plant wastewaters, desalination waste waters, etc.), as well as other salines having a salinity that is greater than that of freshwater. Brine is water saturated or nearly saturated with salt and has a salinity that is 50 ppt (parts per thousand) or greater. Brackish water is water that is saltier than fresh water, but not as salty as seawater, having a salinity ranging from 0.5 to 35 ppt. Seawater is water from a sea or ocean and has a salinity ranging from 35 to 50 ppt. The saltwater source from which the mineral composition that is a major component of the CO₂ sequestering component of the soil stabilization compositions of the invention is derived may be a naturally occurring source, such as a sea, ocean, lake, swamp, estuary, lagoon, etc., or a man-made source. In certain embodiments, the saltwater source of the mineral composition is seawater.

In some embodiments, the saltwater source from which the mineral composition that is a major component of the CO₂ sequestering component of the soil stabilization compositions of the invention is derived may be a brine, such as a naturally occurring brine originating in a subterranean location, an industrial waste brine, a desalination effluent brine, a synthetic brine, a brine augmented with minerals, a brine augmented with silica, a brine augmented with metal ions, or any combination thereof.

While the present invention is described primarily in terms of saltwater sources, in certain embodiments, the water employed in the invention may be a mineral rich, e.g., calcium and/or magnesium rich, freshwater source. The water employed in the process is one that includes one or more alkaline earth metals, e.g., magnesium, calcium, etc, and is another type of alkaline-earth-metal-containing water that finds use in embodiments of the invention. Waters of interest include those that include calcium in amounts ranging from 50 to 20,000 ppm, such as 100 to 10,0000 ppm and including 200 to 5000 ppm. Waters of interest include those that include magnesium in amounts ranging from 50 to 20,000 ppm, such as 200 to 10000 ppm and including 500 to 5000 ppm.

The saltwater-derived carbonate and/or bicarbonate compound compositions are ones that are derived from a saltwater. As such, they are compositions that are obtained from a saltwater in some manner, e.g., by treating a volume of a saltwater in a manner sufficient to produce the desired carbonate and/or bicarbonate compound composition from the initial volume of saltwater. The carbonate and/or bicarbonate compound compositions of certain embodiments are produced by precipitation from a water, e.g., a saltwater, a water that includes alkaline earth metals, such as calcium and magnesium, etc., where such waters are collectively referred to as alkaline-earth-metal-containing waters.

The saltwater employed in methods may vary. As reviewed above, saltwaters of interest include brackish water, sea water and brine, as well as other salines having a salinity that is greater than that of freshwater, which has a salinity of less than 5 ppt dissolved salts. In some embodiments, for example, calcium rich waters may be combined with magnesium silicate minerals, such as olivine or serpentine, in solution that has become acidic due to the addition on carbon dioxide to form carbonic acid, which dissolves the magnesium silicate, leading to the formation of calcium magnesium silicate carbonate compounds as mentioned above.

In methods of producing the carbonate and/or bicarbonate compound compositions of the soil stabilization compositions of the invention, a volume of water is subjected to carbonate compound precipitation conditions sufficient to produce a precipitated carbonate and/or bicarbonate compound composition and a mother liquor (i.e., the part of the water that is left over after precipitation of the carbonate compound(s) from the saltwater). The resultant precipitates and mother liquor collectively make up the carbonate and/or bicarbonate compound compositions of the invention. Any convenient precipitation conditions may be employed, which conditions result in the production of a sequestration product containing carbonate, bicarbonate or carbonate and bicarbonate compound compositions.

Precipitation conditions of interest may vary. For example, the temperature of the water may be within a suitable range for the precipitation of the desired mineral to occur. In some embodiments, the temperature of the water may be in a range from 0 to 70° C., such as from 0 to 50° C., such as from 3 to 50° C., and including 3 to 20° C. In some embodiments, the temperature of the water may be in a range from 5 to 70° C., such as from 20 to 50° C. and including from 25 to 45° C. As such, while a given set of precipitation conditions may have a temperature ranging from 0 to 100° C., the temperature may be adjusted in certain embodiments to produce the desired precipitate.

In normal sea water, 93% of the dissolved CO₂ is in the form of bicarbonate ions (HCO₃⁻) and 6% is in the form of carbonate ions (CO₃⁻²). When calcium carbonate precipitates from normal sea water, CO₂ is released. In fresh water, above pH 10.33, greater than 90% of the carbonate is in the form of carbonate ion, and no CO₂ is released during the precipitation of calcium carbonate. In sea water this transition occurs at a slightly lower pH, closer to a pH of 9.7. While the pH of the water employed in methods may range from 4 to 14 during a given precipitation process, in certain embodiments the pH may be raised to alkaline levels in order to drive the precipitation of carbonate compounds, as well as other compounds, e.g., hydroxide compounds, as desired. In certain of these embodiments, the pH is raised to a level which minimizes if not eliminates CO₂ production during precipitation, causing dissolved CO₂, e.g., in the form of carbonate and bicarbonate, to be trapped in the carbonate compound precipitate. In these embodiments, the pH may be raised to 10 or higher, such as 11 or higher.

The pH of the water may be raised using any convenient approach. In certain embodiments, a pH raising agent may be employed, where examples of such agents include oxides, hydroxides (e.g., calcium oxide in fly ash, potassium hydroxide, sodium hydroxide, brucite (Mg(OH₂), etc.), carbonates (e.g., sodium carbonate) and the like. One such approach is to use the coal ash from a coal-fired power plant, which contains many oxides, to elevate the pH of sea water. Other coal processes, like the gasification of coal, to produce syngas, also produce hydrogen gas and carbon monoxide, and may serve as a source of hydroxide as well. Some naturally occurring minerals, such as serpentine, contain hydroxide, and can be dissolved, yielding a hydroxide source. The addition of serpentine, also releases silica and magnesium into the solution, leading to the formation of silica containing carbonate compounds. The amount of pH elevating agent that is added to the water will depend on the particular nature of the agent and the volume of saltwater being modified, and will be sufficient to adjust and maintain the pH of the water to the desired value. Alternatively, the pH of the saltwater source can be adjusted to the desired level by electrolysis of the water. Where electrolysis is employed, a variety of different protocols may be taken, such as use of the Mercury cell process (also called the Castner-Kellner process); the Diaphragm cell process and the membrane cell process. Where desired, byproducts of the hydrolysis product, e.g., H₂, sodium metal, etc. may be harvested and employed for other purposes, as desired.

Methods of the invention include contacting a volume of an aqueous solution of divalent cations with a source of CO₂ (to dissolve CO₂) and subjecting the resultant solution to precipitation conditions. In some embodiments, a volume of an aqueous solution of divalent cations is contacted with a source of CO₂ (to dissolve CO₂) while subjecting the aqueous solution to precipitation conditions. The dissolution of CO₂ into the aqueous solution of divalent cations produces carbonic acid, a species in equilibrium with both bicarbonate and carbonate. In order to produce carbonate-containing precipitation material, protons are removed from various species (e.g. carbonic acid, bicarbonate, hydronium, etc.) in the divalent cation-containing solution to shift the equilibrium toward carbonate. As protons are removed, more CO₂ goes into solution. In some embodiments, proton-removing agents and/or methods are used while contacting a divalent cation-containing aqueous solution with CO₂ to increase CO₂ absorption in one phase of the precipitation reaction, wherein the pH may remain constant, increase, or even decrease, followed by a rapid removal of protons (e.g., by addition of a base) to cause rapid precipitation of carbonate-containing precipitation material. Protons may be removed from the various species (e.g. carbonic acid, bicarbonate, hydronium, etc.) by any convenient approach, including, but not limited to use of naturally occurring proton-removing agents, use of microorganisms and fungi, use of synthetic chemical proton-removing agents, recovery of man-made waste streams, and using electrochemical means.

Naturally occurring proton-removing agents encompass any proton-removing agents that can be found in the wider environment that may create or have a basic local environment. Some embodiments provide for naturally occurring proton-removing agents including minerals that create basic environments upon addition to solution. Such minerals include, but are not limited to, lime (CaO); periclase (MgO); iron hydroxide minerals (e.g., goethite and limonite); and volcanic ash. Methods for digestion of such minerals and rocks comprising such minerals are provided herein. Some embodiments provide for using naturally alkaline bodies of water as naturally occurring proton-removing agents. Examples of naturally alkaline bodies of water include, but are not limited to surface water sources (e.g. alkaline lakes such as Mono Lake in California) and ground water sources (e.g. basic aquifers such as the deep geologic alkaline aquifers located at Searles Lake in California). Other embodiments provide for use of deposits from dried alkaline bodies of water such as the crust along Lake Natron in Africa's Great Rift Valley. In some embodiments, organisms that excrete basic molecules or solutions in their normal metabolism are used as proton-removing agents. Examples of such organisms are fungi that produce alkaline protease (e.g., the deep-sea fungus Aspergillus ustus with an optimal pH of 9) and bacteria that create alkaline molecules (e.g., cyanobacteria such as Lyngbya sp. from the Atlin wetland in British Columbia, which increases pH from a byproduct of photosynthesis). In some embodiments, organisms are used to produce proton-removing agents, wherein the organisms (e.g., Bacillus pasteurii, which hydrolyzes urea to ammonia) metabolize a contaminant (e.g. urea) to produce proton-removing agents or solutions comprising proton-removing agents (e.g., ammonia, ammonium hydroxide). In some embodiments, organisms are cultured separately from the precipitation reaction mixture, wherein proton-removing agents or solution comprising proton-removing agents are used for addition to the precipitation reaction mixture. In some embodiments, naturally occurring or manufactured enzymes are used in combination with proton-removing agents to invoke precipitation of precipitation material. Carbonic anhydrase, which is an enzyme produced by plants and animals, accelerates transformation of carbonic acid to bicarbonate in aqueous solution.

Chemical agents for effecting proton removal generally refer to synthetic chemical agents that are produced in large quantities and are commercially available. For example, chemical agents for removing protons include, but are not limited to, hydroxides, organic bases, super bases, oxides, ammonia, and carbonates. Hydroxides include chemical species that provide hydroxide anions in solution, including, for example, sodium hydroxide (NaOH), potassium hydroxide (KOH), calcium hydroxide (Ca(OH)₂), or magnesium hydroxide (Mg(OH)₂). Organic bases are carbon-containing molecules that are generally nitrogenous bases including primary amines such as methyl amine, secondary amines such as diisopropylamine, tertiary such as diisopropylethylamine, aromatic amines such as aniline, heteroaromatics such as pyridine, imidazole, and benzimidazole, and various forms thereof. In some embodiments, an organic base selected from pyridine, methylamine, imidazole, benzimidazole, histidine, and a phosphazene is used to remove protons from various species (e.g., carbonic acid, bicarbonate, hydronium, etc.) for precipitation of precipitation material. In some embodiments, the organic base may be acetate, propionate, butyrate, valerate or a combination thereof. In some embodiments, ammonia is used to raise pH to a level sufficient to precipitate precipitation material from a solution of divalent cations and an industrial waste stream. Super bases suitable for use as proton-removing agents include sodium ethoxide, sodium amide (NaNH₂), sodium hydride (NaH), butyl lithium, lithium diisopropylamide, lithium diethylamide, and lithium bis(trimethylsilyl)amide. Oxides including, for example, calcium oxide (CaO), magnesium oxide (MgO), strontium oxide (SrO), beryllium oxide (BeO), and barium oxide (BaO) are also suitable proton-removing agents that may be used. Carbonates for use in the invention include, but are not limited to, sodium carbonate.

In addition to comprising cations of interest and other suitable metal forms, waste streams from various industrial processes may provide proton-removing agents. Such waste streams include, but are not limited to, mining wastes; fossil fuel burning ash (e.g., combustion ash such as fly ash, bottom ash, boiler slag); slag (e.g. iron slag, phosphorous slag); cement kiln waste; oil refinery/petrochemical refinery waste (e.g. oil field and methane seam brines); coal seam wastes (e.g. gas production brines and coal seam brine); paper processing waste; water softening waste brine (e.g., ion exchange effluent); silicon processing wastes; agricultural waste; metal finishing waste; high pH textile waste; and caustic sludge. Mining wastes include any wastes from the extraction of metal or another precious or useful mineral from the earth. In some embodiments, wastes from mining are used to modify pH, wherein the waste is selected from red mud from the Bayer aluminum extraction process; waste from magnesium extraction from sea water (e.g., Mg(OH)₂ such as that found in Moss Landing, Calif.); and wastes from mining processes involving leaching. For example, red mud may be used to modify pH as described in U.S. Provisional Patent Application No. 61/161,369, titled, “NEUTRALIZING INDUSTRIAL WASTES UTILIZING CO₂ AND A DIVALENT CATION SOLUTION”, filed 18 Mar. 2009, which is hereby incorporated by reference in its entirety. Fossil fuel burning ash, cement kiln dust, and slag, collectively waste sources of metal oxides, further described in U.S. patent application Ser. No. 12/486,692, titled, “METHODS AND SYSTEMS FOR UTILIZING WASTE SOURCES OF METAL OXIDES,” filed 17 Jun. 2009, the disclosure of which is incorporated herein in its entirety, may be used in alone or in combination with other proton-removing agents to provide proton-removing agents for the invention. Agricultural waste, either through animal waste or excessive fertilizer use, may contain potassium hydroxide (KOH) or ammonia (NH₃) or both. As such, agricultural waste may be used in some embodiments of the invention as a proton-removing agent. This agricultural waste is often collected in ponds, but it may also percolate down into aquifers, where it can be accessed and used.

Electrochemical methods are another means to remove protons from various species in a solution, either by removing protons from solute (e.g., deprotonation of carbonic acid or bicarbonate) or from solvent (e.g., deprotonation of hydronium or water). Deprotonation of solvent may result, for example, if proton production from CO₂ dissolution matches or exceeds electrochemical proton removal from solute molecules. In some embodiments, low-voltage electrochemical methods are used to remove protons, for example, as CO₂ is dissolved in the precipitation reaction mixture or a precursor solution to the precipitation reaction mixture (i.e., a solution that may or may not contain divalent cations). In some embodiments, CO₂ dissolved in an aqueous solution that does not contain divalent cations is treated by a low-voltage electrochemical method to remove protons from carbonic acid, bicarbonate, hydronium, or any species or combination thereof resulting from the dissolution of CO₂. A low-voltage electrochemical method operates at an average voltage of 2, 1.9, 1.8, 1.7, or 1.6 V or less, such as 1.5, 1.4, 1.3, 1.2, 1.1 V or less, such as 1 V or less, such as 0.9 V or less, 0.8 V or less, 0.7 V or less, 0.6 V or less, 0.5 V or less, 0.4 V or less, 0.3 V or less, 0.2 V or less, or 0.1 V or less. Low-voltage electrochemical methods that do not generate chlorine gas are convenient for use in systems and methods of the invention. Low-voltage electrochemical methods to remove protons that do not generate oxygen gas are also convenient for use in systems and methods of the invention. In some embodiments, low-voltage electrochemical methods generate hydrogen gas at the cathode and transport it to the anode where the hydrogen gas is converted to protons. Electrochemical methods that do not generate hydrogen gas may also be convenient. In some embodiments, electrochemical processes to remove protons do not generate a gas at the anode. In some instances, electrochemical methods to remove protons do not generate any gaseous by-byproduct. In some embodiments, carbon dioxide is introduced into the electrolyte in contact with the cathode. Electrochemical methods for effecting proton removal are further described in U.S. patent application Ser. No. 12/344,019, titled, “METHODS OF SEQUESTERING CO₂,” filed 24 Dec. 2008; U.S. patent application Ser. No. 12/375,632, titled, “LOW ENERGY ELECTROCHEMICAL HYDROXIDE SYSTEM AND METHOD,” filed 23 Dec. 2008; International Patent Application No. PCT/U.S. 08/088,242, titled, “LOW ENERGY ELECTROMECHANICAL HYDROXIDE SYSTEM AND METHOD,” filed 23 Dec. 2008; International Patent Application No. PCT/U.S. 09/32301, titled, “LOW-ENERGY ELECTROCHEMICAL BICARBONATE ION SOLUTION,” filed 28 Jan. 2009; and International Patent Application No. PCT/U.S. 09/48511, titled, “LOW-ENERGY 4-CELL ELECTROCHEMICAL SYSTEM WITH CARBON DIOXIDE GAS,” filed 24 Jun. 2009, each of which are incorporated herein by reference in their entirety.

Alternatively, electrochemical methods may be used to produce caustic molecules (e.g., hydroxide) through, for example, the chlor-alkali process, or modification thereof. Electrodes (i.e., cathodes and anodes) may be present in the apparatus containing the divalent cation-containing aqueous solution or gaseous waste stream-charged (e.g., CO₂-charged) solution, and a selective barrier, such as a membrane, may separate the electrodes. Electrochemical systems and methods for removing protons may produce by-products (e.g., hydrogen) that may be harvested and used for other purposes. Additional electrochemical approaches that may be used in systems and methods of the invention include, but are not limited to, those described in U.S. patent application Ser. No. 12/503,557, titled, “CO₂ UTILIZATION IN ELECTROCHEMICAL SYSTEMS,” filed 15 Jul. 2009 and U.S. Provisional Application No. 61/091,729, titled, “LOW ENERGY ABSORPTION OF HYDROGEN ION FROM AN ELECTROLYTE SOLUTION INTO A SOLID MATERIAL,” filed 11 Sep. 2008, the disclosures of which are herein incorporated by reference.

In some embodiments, the chlor-alkali process or modifications thereof are employed in methods of the invention to produce caustic molecules for proton removal. As is known in the art, the chlor-alkali process employs an electrochemical cell that includes an anode, a cathode, an ion-exchange membrane located between the anode and cathode, and at least one electrolyte made of an aqueous solution of a salt, typically sodium chloride. A potential is applied across the anode and cathode causing evolution of chlorine at the anode and hydrogen at the cathode, as well as the formation of hydroxide ions at the cathode. The hydroxide ions combine with the cation from the salt. When using sodium chloride, the caustic formed is sodium hydroxide. In some embodiments, acid (e.g. HCl) may be introduced into the electrolyte in contact with the anode. In some embodiments, carbonate and/or bicarbonate may be introduced into the electrolyte in contact with the cathode. In some embodiments, carbon dioxide may be introduced into the electrolyte in contact with the cathode. In some embodiments, the cathode is an air or oxygen electrode. In some embodiments, mechanisms may be employed which return or add to the energy needed to perform the chlor-alkali process as described herein. In some embodiments, the hydrogen and chlorine gases formed in the chlor-alkali process are combined and the resulting energy collected. In some embodiments, the hydrogen gas produced by the chlor-alkali process is used in a fuel cell to produce water and energy. In some embodiments, the chlor-alkali process of the invention is located near an industrial plant (e.g. a power plant), and waste heat from the industrial plant is used to recover energy to practice the chlor-alkali process.

Combinations of the above mentioned sources of proton removal may be employed. One such combination is the use of a microorganisms and electrochemical systems. Combinations of microorganisms and electrochemical systems include microbial electrolysis cells, including microbial fuel cells, and bio-electrochemically assisted microbial reactors. In such microbial electrochemical systems, microorganisms (e.g. bacteria) are grown on or very near an electrode and in the course of the metabolism of material (e.g. organic material) electrons are generated that are taken up by the electrode.

In yet other embodiments, the pH elevating approach as described in pending U.S. application Ser. Nos. 61/081,299 titled, “LOW ENERGY pH MODULATION FOR CARBON SEQUESTRATION USING HYDROGEN ABSORPTIVE METAL CATALYSTS”, filed 16 Jul. 2008; and 61/091,729, titled “LOW ENERGY ABSORPTION OF HYDROGEN ION FROM AN ELECTROLYTE SOLUTION INTO A SOLID MATERIAL”, filed 25 Aug. 2008 may be employed, the disclosures of which approaches are herein incorporated by reference.

In some embodiments, the carbonates, bicarbonates, or combination thereof which comprise the CO₂ sequestering component of the soil stabilization composition of the invention are derived from an alkaline-earth metal containing water that includes a CO₂ charged solution. In such embodiments, the carbon dioxide used to charge the CO₂ charged solution may be derived from any convenient source of CO₂, such as, but not limited to: industrial waste gas, compressed carbon dioxide from carbon dioxide recovery processes; atmospheric air or a combination thereof. In some embodiments, the industrial waste gas may include: flue gas from processes that combust fossil fuels; calcining materials to make cement; smelting processes; fermentation processes; or any combination thereof. In some embodiments, the CO₂ charged solution is derived from a source of CO₂ and a contacting solution. In some embodiments, the contacting solution includes sea water, freshwater, or any saltwater or a combination thereof at an appropriate pH to allow for the desired amount of CO₂ incorporation into the contacting solution. In some embodiments, the contacting solution includes: a solution of NaOH; a solution of KOH; an alkaline brine; a clear liquid or a combination thereof. In such embodiments, a clear liquid is a solution that will readily incorporate CO₂ into the solution to remove CO₂ from a CO₂ source stream without forming a carbonate precipitate or bicarbonate precipitate in the clear liquid.

Additives other than pH elevating agents may also be introduced into the water in order to influence the nature of the precipitate that is produced. As such, certain embodiments of the methods include providing an additive in water before or during the time when the water is subjected to the precipitation conditions. Certain calcium carbonate polymorphs can be favored by trace amounts of certain additives. For example, vaterite, a highly unstable polymorph of CaCO₃ which precipitates in a variety of different morphologies and converts rapidly to calcite, can be obtained at very high yields by including trace amounts of lanthanum as lanthanum chloride in a supersaturated solution of calcium carbonate. Other additives beside lanthanum that are of interest include, but are not limited to transition metals and the like. For instance, the addition of ferrous or ferric iron is known to favor the formation of disordered dolomite (protodolomite) where it would not form otherwise.

The nature of the precipitate can also be influenced by selection of appropriate major ion ratios. Major ion ratios also have considerable influence of polymorph formation. For example, as the magnesium:calcium ratio in the water increases, aragonite becomes the favored polymorph of calcium carbonate over low-magnesium calcite. At low magnesium:calcium ratios, low-magnesium calcite is the preferred polymorph. As such, a wide range of magnesium:calcium ratios can be employed, including, e.g., 100/1, 50/1, 20/1, 10/1, 5/1, 2/1, 1/1, 1/2, 1/5, 1/10, 1/20, 1/50, 1/100. In certain embodiments, the magnesium:calcium ratio is determined by the source of water employed in the precipitation process (e.g., seawater, brine, brackish water, fresh water), whereas in other embodiments, the magnesium:calcium ratio is adjusted to fall within a certain range.

Rate of precipitation also has a large effect on compound phase formation. The most rapid precipitation can be achieved by seeding the solution with a desired phase. Without seeding, rapid precipitation can be achieved by rapidly increasing the pH of the sea water, which results in more amorphous constituents. When silica is present, the more rapid the reaction rate, the more silica is incorporated with the carbonate precipitate. The higher the pH is, the more rapid the precipitation is and the more amorphous the precipitate is.

Accordingly, a set of precipitation conditions to produce a desired precipitate from a water include, in certain embodiments, the water's temperature and pH, and in some instances the concentrations of additives and ionic species in the water. Precipitation conditions may also include factors such as mixing rate, forms of agitation such as ultrasonics, and the presence of seed crystals, catalysts, membranes, or substrates. In some embodiments, precipitation conditions include supersaturated conditions, temperature, pH, and/or concentration gradients, or cycling or changing any of these parameters. The protocols employed to prepare carbonate compound precipitates according to the invention may be batch or continuous protocols. It will be appreciated that precipitation conditions may be different to produce a given precipitate in a continuous flow system compared to a batch system.

In certain embodiments, the methods further include contacting the volume of water that is subjected to the mineral precipitation conditions with a source of CO₂. Contact of the water with the source CO₂ may occur before and/or during the time when the water is subjected to CO₂ precipitation conditions. Accordingly, embodiments of the invention include methods in which the volume of water is contacted with a source of CO₂ prior to subjecting the volume of saltwater to mineral precipitation conditions. Embodiments of the invention include methods in which the volume of salt water is contacted with a source of CO₂ while the volume of saltwater is being subjected to carbonate compound precipitation conditions. Embodiments of the invention include methods in which the volume of water is contacted with a source of a CO₂ both prior to subjecting the volume of saltwater to compound precipitation conditions and while the volume of saltwater is being subjected to carbonate compound precipitation conditions. In some embodiments, the same water may be cycled more than once, wherein a first cycle of precipitation removes primarily calcium carbonate minerals, calcium bicarbonate minerals, or a combination thereof and magnesium carbonate minerals, magnesium bicarbonate, or a combination thereof, and leaves remaining alkaline water to which other alkaline earth ion sources may be added, that can have more carbon dioxide cycled through it, precipitating more carbonate compounds.

The source of CO₂ that is contacted with the volume of saltwater in these embodiments may be any convenient CO₂ source. The CO₂ source may be a liquid, solid (e.g., dry ice), supercritical fluid or gaseous CO₂ source. In certain embodiments, the CO₂ source is a gaseous CO₂ source. This gaseous CO₂ is, in certain instances, a waste feed from an industrial plant. The nature of the industrial plant may vary in these embodiments, where industrial plants of interest include power plants (e.g., as described in further detail in U.S. Provisional Application Ser. No. 61/057,173, titled, “SEQUESTERING POWER PLANT GENERATED CO2” filed 29 May 2008, the disclosure of which is herein incorporated by reference), chemical processing plants, steel mills, paper mills, cement plants (e.g., as described in further detail in U.S. Provisional Application Ser. No. 61/088,340, titled “MEANS FOR REDUCING CO2 EMISSIONS IN PORTLAND CEMENT PRODUCTION,” filed 12 Aug. 2008, the disclosure of which is herein incorporated by reference), and other industrial plants that produce CO₂ as a byproduct. By waste feed is meant a stream of gas (or analogous stream) that is produced as a byproduct of an active process of the industrial plant. The gaseous stream may be substantially pure CO₂ or a multi-component gaseous stream that includes CO₂ and one or more additional gases. Multi-component gaseous streams (containing CO₂) that may be employed as a CO₂ source in embodiments of the subject methods include both reducing, e.g., syngas, shifted syngas, natural gas, and hydrogen and the like, and oxidizing condition streams, e.g., flue gases from combustion. Exhaust gases containing NOx, SOx, VOCs, particulates and Hg would commonly incorporate these compounds along with the carbonate in the precipitated product. Particular multi-component gaseous streams of interest that may be treated according to the subject invention include: oxygen containing combustion power plant flue gas, turbo charged boiler product gas, coal gasification product gas, shifted coal gasification product gas, anaerobic digester product gas, wellhead natural gas stream, reformed natural gas or methane hydrates, and the like.

The volume of saltwater may be contacted with the CO₂ source using any convenient protocol. Where the CO₂ is a gas, contact protocols of interest include, but are not limited to: direct contacting protocols, e.g., bubbling the gas through the volume of saltwater, concurrent contacting means, i.e., contact between unidirectionally flowing gaseous and liquid phase streams, countercurrent means, i.e., contact between oppositely flowing gaseous and liquid phase streams, and the like. Thus, contact may be accomplished through use of infusers, bubblers, fluidic Venturi reactor, sparger, gas filter, spray, tray, or packed column reactors, and the like, as may be convenient.

The above protocol results in the production of a slurry of a CO₂ sequestering precipitate and a mother liquor. Where desired, the compositions made up of the precipitate and the mother liquor may be stored for a period of time following precipitation and prior to further processing. For example, the composition may be stored for a period of time ranging from 1 to 1000 days or longer, such as 1 to 10 days or longer, at a temperature ranging from 1 to 40° C., such as 20 to 25° C.

The slurry components are then separated. Embodiments may include treatment of the mother liquor, where the mother liquor may or may not be present in the same composition as the product. For example, where the mother liquor is to be returned to the ocean, the mother liquor may be contacted with a gaseous source of CO₂ in a manner sufficient to increase the concentration of carbonate ion present in the mother liquor. Contact may be conducted using any convenient protocol, such as those described above. In certain embodiments, the mother liquor has an alkaline pH, and contact with the CO₂ source is carried out in a manner sufficient to reduce the pH to a range between 5 and 9, e.g., 6 and 8.5, including 7.5 to 8.2. In certain embodiments, the treated brine may be contacted with a source of CO₂, e.g., as described above, to sequester further CO₂. For example, where the mother liquor is to be returned to the ocean, the mother liquor may be contacted with a gaseous source of CO₂ in a manner sufficient to increase the concentration of carbonate ion present in the mother liquor. Contact may be conducted using any convenient protocol, such as those described above. In certain embodiments, the mother liquor has an alkaline pH, and contact with the CO₂ source is carried out in a manner sufficient to reduce the pH to a range between 5 and 9, e.g., 6 and 8.5, including 7.5 to 8.2.

The resultant mother liquor of the reaction may be disposed of using any convenient protocol. In certain embodiments, it may be sent to a tailings pond for disposal. In certain embodiments, it may be disposed of in a naturally occurring body of water, e.g., ocean, sea, lake or river. In certain embodiments, the mother liquor is returned to the source of feedwater for the methods of invention, e.g., an ocean or sea. Alternatively, the mother liquor may be further processed, e.g., subjected to desalination protocols, as described further in U.S. application Ser. No. 12/163,205, publication number US 2009-0001020 A1, titled “DESALINATION METHODS AND SYSTEMS THAT INCLUDE CARBONATE COMPOUND PRECIPITATION,” filed 27 Jun. 2008; the disclosure of which is herein incorporated by reference.

In certain embodiments, following production of the CO₂ sequestering product, the resultant product is separated from the mother liquor to produce separated CO₂ sequestering product. Separation of the product can be achieved using any convenient approach, including a mechanical approach, e.g., where bulk excess water is drained from the product, e.g., either by gravity alone or with the addition of vacuum, mechanical pressing, by filtering the product from the mother liquor to produce a filtrate, etc. Separation of bulk water produces, in certain embodiments, a wet, dewatered precipitate.

The resultant dewatered precipitate may then be dried, as desired, to produce a dried product. Drying can be achieved by air drying the wet precipitate. Where the wet precipitate is air dried, air drying may be at room or elevated temperature. In yet another embodiment, the wet precipitate is spray dried to dry the precipitate, where the liquid containing the precipitate is dried by feeding it through a hot gas (such as the gaseous waste stream from the power plant), e.g., where the liquid feed is pumped through an atomizer into a main drying chamber and a hot gas is passed as a co-current or counter-current to the atomizer direction. Depending on the particular drying protocol of the system, the drying station may include a filtration element, freeze drying structure, spray drying structure, etc. Where desired, the dewatered precipitate product may be washed before drying. The precipitate may be washed with freshwater, e.g., to remove salts (such as NaCl) from the dewatered precipitate.

In certain embodiments, the precipitate product is refined (i.e., processed) in some manner prior to subsequent use. Refinement may include a variety of different protocols. In certain embodiments, the product is subjected to mechanical refinement, e.g., grinding, in order to obtain a product with desired physical properties, e.g., particle size, etc.

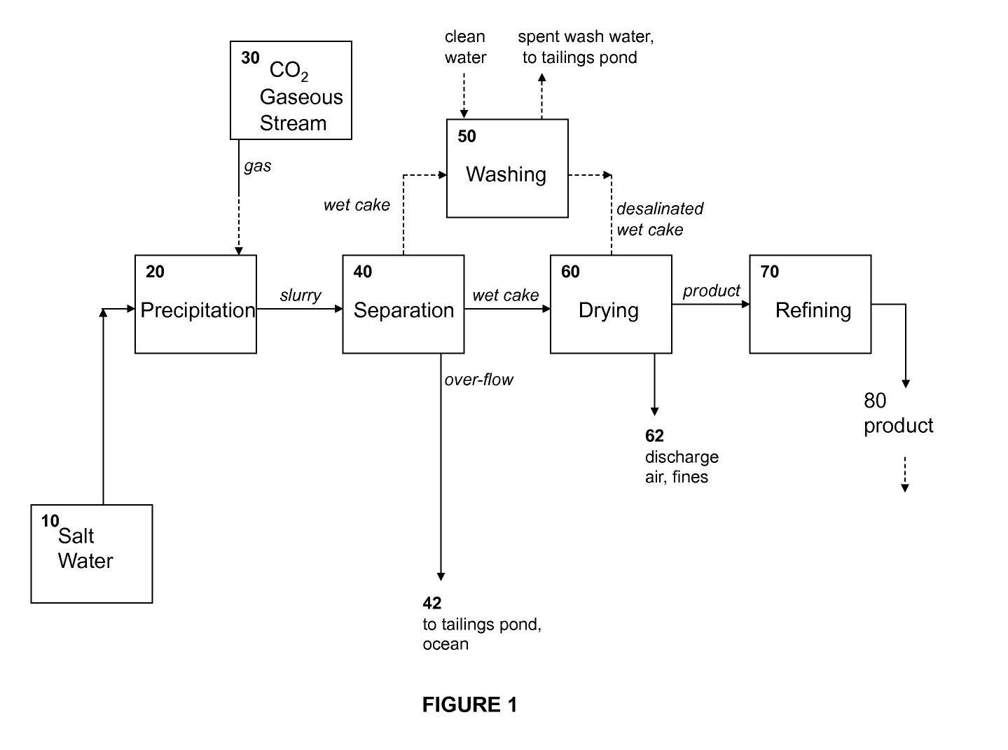

FIG. 1 provides a schematic flow diagram of a process for producing a CO₂ sequestering product according to an embodiment of the invention. In FIG. 1, saltwater from salt water source 10 is subjected to carbonate and/or bicarbonate compound precipitation conditions at precipitation step 20. As reviewed above, term “saltwater” is employed in its conventional sense to refer a number of different types of aqueous fluids other than fresh water, where the term “saltwater” includes brackish water, sea water and brine (including man-made brines, e.g., geothermal plant wastewaters, desalination waste waters, etc), as well as other salines having a salinity that is greater than that of freshwater. The saltwater source from which the carbonate compound composition of the cements of the invention is derived may be a naturally occurring source, such as a sea, ocean, lake, swamp, estuary, lagoon, etc., or a man-made source.

In certain embodiments, the water may be obtained from the power plant that is also providing the gaseous waste stream. For example, in water cooled power plants, such as seawater cooled power plants, water that has been employed by the power plant may then be sent to the precipitation system and employed as the water in the precipitation reaction. In certain of these embodiments, the water may be cooled prior to entering the precipitation reactor.

In the embodiment depicted in FIG. 1, the water from saltwater source 10 is first charged with CO₂ to produce CO₂ charged water, which CO₂ charged water is then subjected to carbonate and/or bicarbonate compound precipitation conditions. As depicted in FIG. 1, a CO₂ gaseous stream 30 is contacted with the water at precipitation step 20. The provided gaseous stream 30 is contacted with a suitable water at precipitation step 20 to produce a CO₂ charged water. By CO₂ charged water is meant water that has had CO₂ gas contacted with it, where CO₂ molecules have combined with water molecules to produce, e.g., carbonic acid, bicarbonate and carbonate ion. Charging water in this step results in an increase in the “CO₂ content” of the water, e.g., in the form of carbonic acid, bicarbonate and carbonate ion, and a concomitant decrease in the pCO₂ of the waste stream that is contacted with the water. The CO₂ charged water is acidic, having a pH of 6 or less, such as 5 or less and including 4 or less. In certain embodiments, the concentration of CO₂ of the gas that is used to charge the water is 10% or higher, 25% or higher, including 50% or higher, such as 75% or even higher. Contact protocols of interest include, but are not limited to: direct contacting protocols, e.g., bubbling the gas through the volume of water, concurrent contacting means, i.e., contact between unidirectionally flowing gaseous and liquid phase streams, countercurrent means, i.e., contact between oppositely flowing gaseous and liquid phase streams, and the like. Thus, contact may be accomplished through use of infusers, bubblers, fluidic Venturi reactor, sparger, gas filter, spray, tray, or packed column reactors, and the like, as may be convenient.

At precipitation step 20, carbonate compounds, bicarbonate compounds, or a mixture of carbonate and bicarbonate compounds, which may be amorphous or crystalline, are precipitated. Precipitation conditions of interest include those that change the physical environment of the water to produce the desired precipitate product. For example, the temperature of the water may be adjusted to a temperature suitable for precipitation of the desired carbonate compound(s) to occur. In such embodiments, the temperature of the water may be adjusted to a value from 0 to 70° C., such as from 0 to 50° C., such as from 3 to 50° C., and including 3 to 20° C. In some embodiments, the temperature of the water may be adjusted to a value from 5 to 70° C., such as from 20 to 50° C. and including from 25 to 45° C. As such, while a given set of precipitation conditions may have a temperature ranging from 0 to 100° C., the temperature may be adjusted in certain embodiments to produce the desired precipitate. In certain embodiments, the temperature is raised using energy generated from low or zero carbon dioxide emission sources, e.g., solar energy source, wind energy source, hydroelectric energy source, etc. While the pH of the water may range from 7 to 14 during a given precipitation process, in certain embodiments the pH is raised to alkaline levels in order to drive the precipitation of carbonate compound as desired. In certain of these embodiments, the pH is raised to a level which minimizes if not eliminates CO₂ gas generation production during precipitation. In these embodiments, the pH may be raised to 10 or higher, such as 11 or higher. Where desired, the pH of the water is raised using any convenient approach. In certain embodiments, a pH raising agent may be employed, where examples of such agents include oxides, hydroxides (e.g., sodium hydroxide, potassium hydroxide, brucite), carbonates (e.g. sodium carbonate) and the like. The amount of pH elevating agent that is added to the saltwater source will depend on the particular nature of the agent and the volume of saltwater being modified, and will be sufficient to raise the pH of the salt water source to the desired value. Alternatively, the pH of the saltwater source can be raised to the desired level by electrolysis of the water.

CO₂ charging and carbonate and/or bicarbonate compound precipitation may occur in a continuous process or at separate steps. As such, charging and precipitation may occur in the same reactor of a system, e.g., as illustrated in FIG. 1 at step 20, according to certain embodiments of the invention. In yet other embodiments of the invention, these two steps may occur in separate reactors, such that the water is first charged with CO₂ in a charging reactor and the resultant CO₂ charged water is then subjected to precipitation conditions in a separate reactor.

Following production of the carbonate and/or bicarbonate precipitate from the water, the resultant precipitated carbonate and/or bicarbonate compound composition is separated from the mother liquor to produce separated carbonate compound, bicarbonate compound or combination thereof compound precipitate product, as illustrated at step 40 of FIG. 1. Separation of the precipitate can be achieved using any convenient approach, including a mechanical approach, e.g., where bulk excess water is drained from the precipitated, e.g., either by gravity alone or with the addition of vacuum, mechanical pressing, by filtering the precipitate from the mother liquor to produce a filtrate, etc. Separation of bulk water produces a wet, dewatered precipitate.

The resultant dewatered precipitate is then dried to produce a product, as illustrated at step 60 of FIG. 1. Drying can be achieved by air drying the filtrate. Where the filtrate is air dried, air drying may be at room or elevated temperature. In yet another embodiment, the precipitate is spray dried to dry the precipitate, where the liquid containing the precipitate is dried by feeding it through a hot gas (such as the gaseous waste stream from the power plant), e.g., where the liquid feed is pumped through an atomizer into a main drying chamber and a hot gas is passed as a co-current or counter-current to the atomizer direction. Depending on the particular drying protocol of the system, the drying station may include a filtration element, freeze drying structure, spray drying structure, etc.

Where desired, the dewatered precipitate product from the separation reactor 40 may be washed before drying, as illustrated at optional step 50 of FIG. 1. The precipitate may be washed with freshwater, e.g., to remove salts (such as NaCl) from the dewatered precipitate. Used wash water may be disposed of as convenient, e.g., by disposing of it in a tailings pond, etc.

At step 70, the dried precipitate is refined, e.g., to provide for desired physical characteristics, such as particle size, surface area, etc., or to add one or more components to the precipitate, such as admixtures, aggregate, supplementary cementitious materials, etc., to produce a final product 80.

In certain embodiments, a system is employed to perform the above methods.

Following production of the CO₂ sequestering component, e.g., as described above, the CO₂ sequestering component is then employed to produce a soil stabilization composition of the invention.

Depending on the particular composition of soil, geographical location of the soil or type of soil stabilized structure, the amount of CO₂ sequestering component that is present may vary. In some instances, the amount of CO₂ sequestering component in the soil stabilization composition ranges from 5 to 100% w/w, such as 5 to 90% w/w including 5 to 50% w/w and also including 5 to 25% w/w. The CO₂ sequestering component in the soil stabilization composition may be admixed with other components, if necessary (discussed below), as an aqueous solution, colloidal suspension, slurry, viscous gel or paste. The CO₂ sequestering component may also be admixed with other components of the soil stabilization composition, when necessary, as a dry powder.

In certain embodiments of the CO₂ sequestering soil stabilization compositions of the invention, the CO₂ sequestering carbonate composition is the only constituent of the CO₂ sequestering soil stabilization composition (i.e., 100% w/w). As such, the CO₂ sequestering carbonate compound may be admixed with soil as an aqueous solution, colloidal suspension, slurry, viscous gel or paste. The CO₂ sequestering component may also be admixed with soil as a dry powder.

In other embodiments of the present invention, the CO₂ sequestering soil stabilization compositions include a cementitious component. By cementitious component is meant a material that provides the plasticity and the cohesive and adhesive properties necessary for placement and the formation of a rigid mass upon mixing with water, with or without aggregate. Cementitious components for use in the present invention may be inorganic hydraulic cements which on hydration form relatively insoluble bonded aggregations possessing considerable strength and dimensional stability, including carbon negative (i.e. CO₂ sequestering) cement. Cement may be formed from materials that contain calcium such as limestone, chalk or marl or materials that contain silica such as clay or shale.

Conventional hydraulic cements are calcium silicates, aluminates and ferrates which when reacted with water form hydrated silicates, aluminates and calcium hydroxide. As conventional hydraulic cement interact with water it swells and forms a gel and sets into interweaved microcrystalline or colloidal clusters of hydrate minerals which are largely (CaO)₃ (SiO₂)₂ (H₂O)₃ and (CaO₄)₄ Al₂O₃ (H₂O). Conventional hydraulic cements of the invention therefore may include (CaO₃) SiO₂, (CaO)₂ SiO₂ (CaO)₃ Al₂O₃ and (CaO)₄ Al₂O₃ Fe₂O₃.

In certain embodiments the cementitious component includes a conventional hydraulic cement (e.g., portland cement). The portland cement component may be any convenient portland cement. As is known in the art, portland cements are powder compositions produced by grinding portland cement clinker (more than 90%), a limited amount of calcium sulfate which controls the set time, and up to 5% minor constituents (as allowed by various standards). As defined by the European Standard EN197.1, “Portland cement clinker is a hydraulic material which shall consist of at least two-thirds by mass of calcium silicates (3CaO.SiO₂ and 2CaO.SiO₂), the remainder consisting of aluminium- and iron-containing clinker phases and other compounds. The ratio of CaO to SiO₂ shall not be less than 2.0. The magnesium content (MgO) shall not exceed 5.0% by mass.” In certain embodiments, the portland cement constituent of the present invention is any portland cement that satisfies the ASTM Standards and Specifications of C150 (Types I-VIII) of the American Society for Testing of Materials (ASTM C50-Standard Specification for Portland Cement). ASTM C150 covers eight types of portland cement, each possessing different properties, and used specifically for those properties.

In other embodiments, the cementitious component of the soil stabilization compositions of the invention is a CO₂ sequestering cement. By CO₂ sequestering cement is meant a powdered cementitious composition that upon mixing with water provides the cohesive and adhesive properties, as well as the plasticity, for the formation of a rigid mass, in which the CO₂ sequestering components stably store a significant amount of CO₂. The CO₂ sequestering cement may be combined with both supplementary cementitious materials and aggregates, both fine and coarse, to form a CO₂ sequestering concrete or building material. In some embodiments, the CO₂ sequestering cement is mixed with calcium oxide, calcium hydroxide, pozzolanic material, or any combination thereof. In such embodiments, the pozzolanic material may be a natural pozzolan (e.g. volcanic ash), a calcined pozzolan, or a combination thereof. The methods and systems of producing these CO₂ sequestering cementitious components are further described in U.S. patent application Ser. No. 12/604,383, titled, “REDUCED-CARBON FOOTPRINT CONCRETE COMPOSITIONS,” filed 22 Oct. 2009 and U.S. Provisional Applications 61/107,645, titled, “LOW-CARBON FOOTPRINT CONCRETE COMPOSITIONS” filed on Oct. 22, 2008; 61/117,542 filed on Nov. 19, 2008; 61/178,360, titled, “Methods and Apparatus for Contacting Gas and Liquid,” filed 14 May 2010; 61/221,457, titled, “Gas-Liquid-Solid Contactor and Precipitator: Apparatus and Methods,” filed, 29 Jun. 2009; 61/221,631, titled, “GAS, LIQUID, SOLID CONTACTING: METHODS AND APPARATUS,” filed 30 Jun. 2009; 61/223,65, titled, “GAS, LIQUID, SOLID CONTACTING: METHODS AND APPARATUS,” 7 Jul. 2009; and 61/289,657, titled, “GAS, LIQUID, SOLID CONTACTING: METHODS AND APPARATUS,” filed, 23 Dec. 2009, the disclosure of which is herein incorporated by reference.

In the embodiments where a cementitious component is added, chemical admixtures may be added to the cementitious component. By chemical admixtures is meant, a group of materials in the form of a powder or fluid, that are added in order to obtain characteristics of the cementitious component that are not obtainable in their absence. In some embodiments, an accelerator may be used. An accelerator is a chemical that is used to increase the rate of hydration of the cementitious component. Such accelerators may be used in embodiments where a rapid setting CO₂-sequestering soil stabilization composition is desired. In some instances, the accelerator may be CaCl₂. In other embodiments, the chemical admixture may be a retarder. A retarder is used to slow the hydration of the cementitious component. A retarder may be used in embodiments in which a slow setting CO₂-sequestering soil stabilization composition is desired. In some instances, the retarder may be a sugar.

Of interest in other embodiments of the CO₂ soil stabilization composition of the invention include the addition of a metal cation. Metal cations may be used to enhance the cation exchange process of soil stabilization. Cations of the present invention can be selected from any of a number of different divalent or trivalent metal cations such as alkaline earth metal cations (e.g., Ca²⁺, Mg²⁺, Ba²⁺, Sr²⁺) or trivalent metal cations (e.g., Al³⁺). Cations of the invention may also be transition metal cations (e.g., Ni²⁺, Cu²⁺, Zn²⁺, Co²⁺, Mo²⁺).

Cation exchange is an important soil stabilization process and can be enhanced by the addition of cations from sources such as metal cation salts, (e.g., calcium nitrite, Ca(NO₃)₂), metal cation silicates (e.g., calcium silicate), or metal cation carbonates (e.g., calcium carbonate). The plasticity of a soil is determined by the amount of expansive clay present. Clay is characterized by stacking of alumina octahedral and silica tetrahedral layers through covalent and ionic bonds. The surfaces of this stacking are negatively charged because of the substitution of aluminum by magnesium. To neutralize the charge deficiency in the crystal structure of clay, water molecules and cations are attracted to these negatively charged surfaces. This results in a diffused separation of two charged surfaces, commonly called a “double layer”. The double layer acts as a lubricant where the thicker the double layer, the more plastic and less stable the soil. The double layer is primarily formed by monovalent cations such as sodium and potassium (Na⁺ and K⁺), and water molecules. However, these monovalent cations can be exchanged with cations of higher valence such as calcium. Upon ion exchange, the higher charge density of di- or trivalent ions results in a significant reduction of the double layer thickness and consequently, an increase in stability of the soil.

Metal cations of the invention may be included in the CO₂ sequestering soil stabilization composition as a salt of the metal cation, such as for example, calcium nitrate, Ca(NO₃)₂. Any convenient anion may also be used such that the metal cation salt sufficiently dissociates to make available the metal cation for cation exchange. Highly hygroscopic salts (e.g., CaSO₄, Ca₃(PO₄)₂) should be avoided in order to minimize the amount of unwanted moisture absorbed into the soil.

In certain embodiments, the pH of the soil will be measured prior to, during, and after the employment of the CO₂ sequestering soil stabilization composition. Soils that have a more highly alkaline pH (i.e., pH>8) usually have higher cation exchange capability. If the pH is less than 6, the soil will generally possesses a lower cation exchange capability. In some instances of the present invention, the pH may be manipulated or maintained in order to enhance cation exchange. Any convenient protocol to manipulate or maintain the optimized pH value may be used, including but not limited to the use of oxides and hydroxides, such as magnesium hydroxide. In some embodiments, the soil stabilization compositions of the invention may be used with calcium oxide, calcium hydroxide, or a combination thereof, in part to affect pH.

In another embodiment of the present invention, the CO₂ sequestering soil stabilization compositions may include a metal silicate. Metal silicates are delaminating agents used to separate the sheets of alumino silicate, allowing the ingress of cations. Silicates may also cause precipitation and neutralization of accelerating agents (which may already be present in the soil (e.g., Fe₂O₃)) to aid in the formation of a stable matrix. Silicates may also be used to retard the setting of the cementitious component, when used, allowing for better hydration in the presence of a cation.

Metal silicates of the present invention may include silicates of any of a number of different metal cations. Of interest in certain embodiments include silicates of metal cations where the cation is selected from divalent or trivalent metal cations such as alkaline earth metal cations (e.g., Ca²⁺, Mg²⁺, Ba²⁺, Sr²⁺) or trivalent metal cations (e.g., Al³⁺). Cations of the invention may also be transition metal cations (e.g., Ni²⁺, Cu²⁺, Zn²⁺, Co²⁺, Mo²⁺). One embodiment of the soil stabilization composition of the invention contains calcium silicate. In another embodiment, the CO₂ sequestering soil stabilization composition of the invention contains magnesium silicate. The metal silicate can be admixed with the soil stabilization composition as an aqueous solution, viscous gel, slurry, or as a colloidal suspension. The metal silicate may also be admixed with the soil stabilization composition as a dry powder. The proportions of metal silicate admixed into the soil stabilization compositions of the invention will vary depending upon the properties of the soil to be stabilized (e.g., porosity, permeability, type of soil, nature or substrata, etc.).

In producing the CO₂ sequestering soil stabilization composition, it is only necessary that the components be blended together, using any convenient mixing device (e.g., rotary mixer, cement mixer), to give a substantially uniform composition.

### Method of Soil Stabilization Using a CO₂ Sequestering Soil Stabilization Composition

Also provided by the present invention are methods of using a CO₂ sequestering soil stabilization composition in order to stabilize soil. As used herein, the term “stabilized soil” refers to a soil has been mixed with the CO₂-sequestering soil stabilization composition of the present invention. The following merely illustrates the principles of the invention. It will be appreciated that those skilled in the art will be able to devise various arrangements and sequences of application which, although not explicitly described or shown herein, embody the principles of the invention and are included within its spirit and scope.

In any of the various treatments within the scope of the present invention, the soil may either be treated in situ or may be temporarily removed for treatment.

The methods for soil stabilization of the current invention are described in greater detail according to each of the following steps.

In certain embodiments, prior to utilizing the CO₂ sequestering soil stabilization composition, the surface to be treated may be first scraped, scarified, or otherwise loosened, and large bedrock, old asphalt structures, unwanted vegetation or gravel may be removed by any convenient protocol.

In other embodiments, since different soil types in different regions may possess varying amounts of moisture content, prior to the application of the CO₂ sequestering soil stabilization composition of the invention, the soil may be dried or water may be added to the soil. The soil may be dried or water may be added using any convenient protocol (e.g., rotary mixer, industrial irrigation tanker).

In other embodiments, since the interaction between a soil stabilizer and soil is strongly influenced by available surface area and uniformity of particle sizes, the soil to be stabilized may be further ground or pulverized. The soil may be ground or pulverized using any convenient protocol prior to the employment of the CO₂ sequestering soil stabilization composition.

The application of the CO₂ sequestering soil stabilization composition may vary. In some instances, the constituents may be admixed in varying proportions depending upon the properties of the soil to be stabilized (e.g., porosity, permeability, type of soil, nature or substrata, etc.). In some embodiments, the CO₂ sequestering soil stabilization composition may be applied as a slurry. By slurry is meant a mixture of any solid that has varying degrees of solubility in a liquid with which it forms a suspension of particles. In other embodiments, the soil stabilization composition may be a paste. The term “paste” is used in its conventional sense to mean a highly viscous mixture of solid and liquid. In yet other embodiments, the soil stabilization composition of the invention may be applied as a solid. The solid may be crystalline or amorphous and is usually in powder form.

Application of the CO₂ sequestering soil stabilizer of the present invention may be accomplished by the use of conventional spray equipment known in the art of road construction and maintenance. It may be gravity fed or pumped through hoses, spray nozzles or fixed sprayers to uniformly apply the compound to the soil to be treated. In other embodiments, the CO₂ soil stabilization compositions of the invention may be poured from a reservoir or applied manually without the use of any industrial machinery. The composition may also be applied by releasing the composition at a depth within the soil by pumping the composition beneath the surface of the soil to be treated or by digging to a depth in the soil using conventional digging machinery and further applying the composition.

In some embodiments of the present invention, the CO₂-sequestering soil stabilization composition of the invention may be mixed after contacting it with the soil. The objective of the mixing process is to obtain an intimate blend of stabilizer and soil to produce the desired property changes. In any of the various treatments within the scope of the present invention, the soil may either be treated in situ or may be temporarily removed from the ground for treatment. Mixing of the CO₂ sequestering soil stabilization composition with soil may be accomplished using any convenient mixing equipment (e.g., rotary mixers, asphalt grinders, cement mixers, etc.). The prepared CO₂-sequestering soil stabilizer and soil mixture is then rotated and blended in a uniform manner. Additional water may be added if necessary to achieve an optimum moisture content. In some embodiments, water may be added to the CO₂ sequestering soil stabilizer and soil mixture (e.g., rotary mixer, industrial irrigation tanker).

In certain embodiments of the invention, the CO₂ sequestering soil stabilization composition and soil mixture will be compacted. Compaction of the CO₂-sequestering soil stabilization composition and soil mixture allows the soil stabilizer particles to achieve their closest packing and maximum density facilitating the soil to reach its highest strength. Compaction may follow immediately after mixing, especially when the soil stabilization composition includes a cementitious component. Compaction may also be delayed after mixing the CO₂-sequestering soil stabilization composition and soil, where such a delay may be 0.5 hours or longer, including 1 hour or longer, 5 hours or longer, 24 hours or longer, and even 100 hours or longer. Compaction of the soil after the application of the CO₂-sequestering soil stabilization composition may be accomplished using any convenient compaction equipment (e.g., sheepsfoot compactor, padfoot compactors, track-type tractors, vibrating smooth drum roller, pneumatic compactors, tandum drum roller, etc.). Compaction may also include the shaping and trimming of the stabilized soil to remove machinery markings and to provide a smooth finish with a proper slope and grade. In certain embodiments, water may be applied to the stabilized soil prior to, during and after compaction. In a preferred embodiment the soil stabilized structures are kept wet while compacting. The amount of moisture used while compacting the stabilized soil may vary depending on the type of soil, and the relative humidity of the environment. In other embodiments, the compaction step may be completed by further employing additional CO₂-sequestering soil stabilizer to the compacted soil surface.

In some embodiments, compaction of the stabilized soil may include shaping into a formed structure. By “formed structure” is meant shaped, molded, cast, cut or otherwise produced, into a man-made structure of defined physical shape, i.e., configuration.

In certain embodiments, a period of curing may be required following compaction of the CO₂-sequestering soil stabilization composition and soil mixture. Sufficient curing will allow the stabilized soil to fully achieve its maximum density and strength. Curing in some embodiments may simply be allowing the stabilized soil in its compacted form to remain open to the air. In other embodiments, the stabilized soil product may be covered with a plastic sheet or the surface may be treated with a liquid sealant in order to reduce the loss of moisture or protect it from the environment. The duration of curing may vary, such as about 0.5 hours or longer, including 1 hour or longer, 5 hours or longer, 24 hours or longer, and even 100 hours or longer. During the curing period, samples from the stabilized soil product may be taken to determine when the stabilized soil product is ready further processing, if necessary.

Another embodiment of the present invention is the use of the CO₂ sequestering soil stabilization composition in the process of full-depth reclamation. By “full-depth reclamation” is meant the in-place recycling of a road or other paved surface structure. A reclaiming machine is used to turn an old asphalt pavement into a surface base by uniformly pulverizing and grinding the old pavement and mixing it with a portion of underlying material. Typically, the process for full depth reclamation involves three steps: 1) the deconstruction and grinding of the original surface; 2) mixing in new stabilization materials; and 3) compacting and grading the new surface.

In one embodiment of full-depth reclamation provided by the present invention, the initial step is the deconstruction and grinding of the existing pavement. The depth of pulverization and grinding may vary, where such depth may be 3 to 18 inches (7.62 to 45.72 cm), such as 4 to 12 inches (10.16 to 30.48 cm), such as 5 to 10 inches (12.70 to 25.40 cm), including 6 to 10 inches (15.24 to 25.40 cm). In some instances, the deconstruction and pulverization of the surface may include some of the subgrade soil in addition to the base surface. The material may be pulverized and ground in situ, or may be removed and subsequently reapplied when necessary. When the reclaimed surface is removed and pulverized in an external grinding apparatus and subsequently reapplied, the steps used for the stabilization of soil as described above may be used to complete the reclamation process.

For in-place deconstruction, once the existing pavement has been sufficiently deconstructed and ground, the material may be shaped and graded to a desired cross-section and grade. In some instances, a small amount of the resultant material may be removed in order to facilitate the desired dimensions for the stabilized structure. For in-place pulverization, once the material is properly graded, the CO₂-sequestering soil stabilization composition of the present invention is applied. Application of the CO₂-sequestering soil stabilization composition may be completed as described above. The CO₂-sequestering soil stabilization composition and pulverized pavement-soil mixture should be mixed and compacted as detailed above. After any necessary curing, the finished grade and slope of the stabilized soil structure may then be prepared. In some instances, the stabilized soil may be further treated with water or an additional layer of CO₂-sequestering soil stabilization composition may be laid upon the surface.

Illustrative CO₂-sequestering soil stabilized structures according to certain embodiments of the invention are now reviewed in greater detail. However, the below review of CO₂-sequestering soil stabilized structures is not limiting on the invention, and is provided solely to further describe various embodiments of the invention.

One type of stabilized soil structure provided by the invention is a landfill. A landfill, also known as a dumpsite or midden, is a site for the disposal of waste materials. Landfills of the present invention may include any internal waste disposal sites (i.e., where a producer of waste carries out their own waste disposal at the place of production) as well as sites used by many producers. Landfills may also used for other waste management purposes, such as the temporary storage, consolidation and transfer, or processing of waste material (e.g., sorting, treatment, or recycling). A landfill may also refer to ground that has been filled in with soil and rocks instead of waste materials, so that it can be used for a specific purpose, such as a storage area for materials utilized in other types of construction.

Another embodiment of a stabilized soil structure is a compost pad. A compost pad is a plot of land of any size utilized in the production, storage or distribution of compost by compost processing and production facilities. By “compost” is meant the aerobically decomposed remnants of organic matter. It is used in landscaping, horticulture and agriculture as a soil conditioner and fertilizer. It is also useful for erosion control, land and stream reclamation, wetland construction, and as landfill cover. The design of a compost pad require that a soil stabilized surface with the appropriate grade, slope and drainage in order to prevent pollution to groundwater and local streams. Also, the compost pad should provide a stable working surface, allowing access to compost through wet weather conditions and helps to prevent the mixing of soil when the compost is turned. In addition, the surface of the compost pad should be stabilized in order to facilitate the use of machinery on its surface throughout the year.

Another type of stabilized soil structure provided by the invention is a road. The term “road” is used in its conventional sense to refer to any identifiable route or path between places. Roads are typically smoothed, paved, or otherwise constructed to allow for easy travel. Roads of the invention may be any length, where such lengths include 0.1 miles (0.16 km) or longer, 1 mile (1.6 km) or longer, 10 miles (16.1 km) or longer, 100 miles or longer, even 1000 miles (160.9 km) or longer. Roads of the invention may also be any width, where such widths include 1 meter or wider, including 5 meters or wider, 10 meters or wider, 100 meters or wider, even 1000 meters or wider. Roads of the invention may facilitate travel for any type of motorized vehicle traffic (e.g., automobile, plane, train, bus, construction vehicles, farming vehicles, etc.). Roads may also be for pedestration traffic. The soil stabilized roads of the invention may be further paved using asphalt, concrete, or any other convenient surface paving material. Roads of the invention may also be left unpaved.

Another type of stabilized soil structure provided by the invention is a building base. By “building base” as used herein, is meant the soil that is situated beneath a conventional building foundation. The building base is the soil on which a building foundation and consequently a building (e.g., commercial or residential) is built upon. In some embodiments, more than one building may reside on a building base. In some instances, a large number of buildings will reside on the soil stabilized building base (e.g., a block of residential homes, a city block of commercial buildings). The dimensions of the building base of the present invention therefore, may vary. In some instances, the building base may have lengths that are 10 meters or longer, such as 100 meters or longer, and including 1000 meters and longer. Similarly, the building base may have widths that are 5 meters and wider, such as 50 meters and wider, and including 500 meters and wider.

Also of interest is stabilized soil that is used to help stabilize built structures that are found in soil. In some instances, the CO₂ sequestering stabilized soil is able to physically reinforce a structure that is located in the soil so as to impede movement within the soil and enable the retention of long-term structural integrity. In some embodiments, soil may be removed from the area surrounding the structure and the CO₂-sequestering soil stabilization composition is applied and mixed with the removed soil. The mixture is then replaced into the area where the soil was removed. After compacting and further shaping, the stabilized soil is allowed to set.

In some instances, the built structure may be a basin that is located in soil or beneath the surface of the soil. The term basin may include any configured container used to hold a liquid, such as water. As such, a basin may include, but is not limited to structures such as wells, collection boxes, sanitary manholes, septic tanks, catch basins, grease traps/separators, storm drain collection reservoirs, etc. Basins may vary in shape, size, and volume capacity. Basins may be rectangular, circular, spherical, or any other shape depending on its intended use. In some instances, the basin may be built directly into the soil (i.e., the basin is constructed of stabilized soil).

In some instances, the built structure may be a conduit that is located in soil, or beneath the surface of the soil. By conduit is meant any tube or analogous structure configured to convey a gas or fluid, from one location to another. Conduits of the current invention can include any of a number of different structures used in the conveyance of a fluid or gas that include, but are not limited to pipes, culverts, box culverts, drainage channels and portals, inlet structures, intake towers, gate wells, outlet structures, and the like. Conduits of the invention may vary considerably in shape and may be determined by hydraulic design and installation conditions. Shapes of conduits of the current invention may include, but are not limited to circular, rectangular, oblong, horseshoe, square, etc. In some instances, the conduit may be built directly into the soil (e.g., irrigation canal, water channel, etc.)

In some instances, the built structure may be a brick, a block, a paving brick, or other structural component. By conduit is meant any tube or analogous structure configured to convey a gas or fluid, from one location to another. Shapes of bricks, blocks, paving brick, or other structural components of the current invention may include, but are not limited to circular, rectangular, oblong, horseshoe, square, etc. In some instances, the brick, block, paving brick or other structural component may be built directly into the soil (e.g., bricks forming a retaining wall, etc.)

Utility

CO₂ sequestering soil stabilization compositions of the invention find use in a variety of different applications. Specific soil stabilized structures in which the soil stabilization composition of the invention find use include, but are not limited to: building (both commercial and residential) bases, roads, pavements, conduits (channels, irrigation channel linings, pipe-linings), basins, landfills, compost pads, etc., and beneath any other type of structure which requires a strong, stabilized base.

The subject methods and systems find use in CO₂ sequestration, particularly via sequestration in the built environment. By “sequestering CO₂” is meant the removal or segregation of CO₂ from the gaseous stream, such as a gaseous waste stream, and fixating it into a stable non-gaseous form so that the CO₂ cannot escape into the atmosphere. By “CO₂ sequestration” is meant the placement of CO₂ into a storage stable form, e.g., a component of the built environment, such as a building base, landfill, compost pad, soil channel, irrigation canal lining, etc. As such, sequestering of CO₂ according to methods of the invention results in prevention of CO₂ gas from entering the atmosphere and long term storage of CO₂ in a manner that CO₂ does not become part of the atmosphere. By storage stable form is meant a form of matter that can be stored above ground or underwater under exposed conditions (i.e., open to the atmosphere, underwater environment, etc.) without significant, if any, degradation for extended durations, e.g., 1 year or longer, 5 years or longer, 10 years or longer, 25 years or longer, 50 years or longer, 100 years or longer, assuming the building material of interest is maintained in its normal environment of its intended use.

### EXAMPLES

### Example 1

In an example of one embodiment of the invention, a soil cement composition is prepared by first scarifying the existing soil to a depth of 12″ (30.48 cm), then adding sufficient water to achieve a 10% by weight moisture content in the soil and remixing the soil. A stabilizing composition comprising a mixture of vaterite, calcite, aragonite and amorphous calcium carbonate which is formed in a precipitation process, described herein above, using flue gas as the CO₂ source and which contains approximately 40% by weight captured CO₂ is then spread evenly over the soil at a rate of 5% by weight based on the weight of the 12″ (30.48 cm) lift of moisture conditioned soil. The stabilizing mixture is then mixed evenly into the 12″ (30.48 cm) soil lift, and compacted with multiple passes with a heavy motorized roller, starting with a sheepsfoot roller and finishing with a smooth roller. The surface of the compacted soil cement is then coated with a thin layer of asphalt emulsion to prevent moisture evaporation, and left to cure for seven days. This soil cement contains sufficient captured CO₂ so that the captured CO₂ content exceeds the CO₂ footprint of the soil cementing process such that the resultant soil cement is carbon negative.

### Example 2

In an example of one embodiment of the invention, a soil cement composition is prepared by first scarifying the existing soil to a depth of 12″ (30.48 cm), then adding sufficient water to achieve a 10% by weight moisture content in the soil and remixing the soil. A stabilizing composition comprising a mixture containing 50% (by weight) portland cement and 50% (by weight) of a blend of vaterite, calcite, aragonite and amorphous calcium carbonate which is formed in a precipitation process using flue gas as the CO₂ source, described herein above, and which contains approximately 40% by weight captured CO₂, is then spread evenly over the soil at a rate of 5% by weight based on the weight of the 12″ (30.48 cm) lift of moisture conditioned soil. The stabilizing mixture is then mixed evenly into the 12″ (30.48 cm) soil lift, and compacted with multiple passes with a heavy motorized roller, starting with a sheepsfoot roller and finishing with a smooth roller. The surface of the compacted soil cement is then coated with a thin layer of asphalt emulsion to prevent moisture evaporation, and left to cure for seven days.

### Example 3

In an example of one embodiment of the invention, a section of asphalt roadway is reclaimed by milling, pulverizing and mixing the existing asphalt roadway, underlying aggregate base and soil base to a depth of 18″ (45.72 cm), then removing 3″ (7.62 cm) of material to allow for maintaining of the previous roadway elevations when fresh asphalt is added later. During the milling process sufficient water is added to achieve a 10% by weight moisture content in the asphalt, aggregate base, soil mixture. A stabilizing composition comprising a mixture containing 50% (by weight) portland cement and 50% (by weight) of a blend of vaterite, calcite, aragonite and amorphous calcium carbonate which is formed in a precipitation process using flue gas as the CO₂ source, described herein above, and which contains approximately 40% by weight captured CO₂, is then spread evenly over the milled mixture at a rate of 5% by weight based on the weight of the 15″ (38.10 cm) lift of moisture conditioned soil. The stabilizing mixture is then mixed evenly into the 15″ (38.10 cm) soil lift, and compacted with multiple passes with a heavy motorized roller, starting with a sheepsfoot roller and finishing with a smooth roller. The surface of the compacted soil cement is then coated with a thin layer of asphalt emulsion to prevent moisture evaporation, and left to cure for seven days. After curing is complete, a wearing course of 3″ (7.62 cm) of dense graded asphalt is applied to the cured reclaimed stabilized section.

### Example 4

In an example of one embodiment of the invention, a soil cement brick is prepared by first screening soil through a 0.25″ (0.635 cm) screen to remove any large clods, mixing the soil with 5% by weight of a stabilizing composition comprising a mixture containing 50% (by weight) portland cement and 50% (by weight) of a blend of vaterite, calcite, aragonite and amorphous calcium carbonate which is formed in a precipitation process using flue gas as the CO₂ source, described herein above, and which contains approximately 40% by weight captured CO₂, placing the mixture into a mold cavity, then applying a pressure of 1,500 to 3,000 psi (10.34 to 20.68 MPa) for approximately 5 seconds to produce a green brick (i.e. an uncured brick). The green bricks are then stacked and covered with plastic to retain moisture, and allowed to cure for 7 days, with full strength achieved after about 28 days.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A soil stabilization composition comprising a CO₂ sequestering component, wherein the CO₂ sequestering component comprises a carbonate compound composition, a bicarbonate compound composition, or any combination thereof and wherein the soil stabilization composition has a δ¹³C value of less than −10‰.

2-3. (canceled)

4. The soil stabilization composition according to claim 1, wherein the carbonate compound composition comprises calcium carbonate, magnesium carbonate, calcium magnesium carbonate, or any combination thereof.

5. The carbonate compound composition of claim 1, wherein the carbonate compound composition comprises amorphous calcium carbonate, vaterite, aragonite, calcite, nesquehonite, hydromagnesite, amorphous magnesium carbonate, anhydrous magnesium carbonate, dolomite, protodolomite, or any combination thereof.

6. The soil stabilization composition according to claim 1, wherein the carbonate compound composition, bicarbonate compound composition, or combination thereof comprises a precipitate from an alkaline-earth metal containing water.

7-14. (canceled)

15. The soil stabilization composition according to of claim 1, wherein the soil stabilization composition further comprises at least one of:
(a) water;
(b) a cementitious component;
(c) a metal cation; and
(d) a metal silicate.

16. The soil stabilization composition according to claim 15, wherein the cementitious component is portland cement, a CO₂ sequestering cement, or a combination thereof.

17. (canceled)

18. The soil stabilization composition according to claim 15, wherein the metal cation comprises sulfur, silicon, strontium, boron, sodium, potassium, lanthium, zinc, iron, or any combination thereof.

19. The soil stabilization composition according to claim 15, wherein the metal silicate comprises magnesium silicate, calcium silicate, aluminum silicate, or any combination thereof.

20. The soil stabilization composition according to claim 15, wherein the CO₂ sequestering component renders the soil stabilization composition reduced in carbon footprint, carbon neutral or carbon negative.

21. A method of soil stabilization, the method comprising the steps of:
(a) obtaining a soil stabilization composition according to claim 1; and
(b) contacting the soil stabilization composition with soil; and
(c) allowing the stabilization composition-contacted soil to set into a solid product; at least 1 of the following steps:
(d) mixing the soil stabilization composition with the contacted soil;
(e) compacting the stabilization composition-contacted soil; and
(f) producing a formed structure from the soil stabilization composition-contacted soil.

22-23. (canceled)

24. The method according to claim 21, wherein the mixing step comprises mechanically mixing the soil stabilization composition with soil in the ground or removing the soil from the ground and mixing the soil stabilization composition with the soil in an external mixer and returning the mixture back to the ground.

25-26. (canceled)

27. The method according to claim 21, wherein the soil stabilization composition is a slurry, a solid, or a paste.

28. The method according to claim 21, wherein the contacting step comprises spraying the soil stabilization composition onto the soil, pouring the soil stabilization composition onto the soil, spraying and pouring the soil stabilization composition onto the soil, or releasing the soil stabilization composition at a depth within the soil.

29-31. (canceled)

32. The method according to claim 21, wherein the allowing step further comprises producing a formed structure, wherein producing the formed structure comprises shaping the soil stabilization-contacted soil or placing the soil stabilization-contacted soil into a mold to produce the formed structure.

33. (canceled)

34. The method according to claim 21, wherein the method is a full-depth reclamation.

35. A soil stabilized structure, the structure comprising:
(a) soil; and
(b) a soil stabilization composition according to claim 1.

36. The soil stabilized structure according to claim 35, wherein the soil stabilized structure is a brick, a block, a paving brick, a landfill, a compost pad, a road, a building base, a basin, a conduit, a channel, an irrigation canal lining, a pipe lining, or other structural component.

37. (canceled)

38. A method of producing a soil stabilization composition, the method comprising:
obtaining a CO₂ sequestering component comprising a carbonate compound composition, a bicarbonate compound composition, or a combination thereof, wherein obtaining the CO₂ sequestering component comprises subjecting an alkaline-earth metal containing water to carbonate and/or bicarbonate precipitation conditions; and
producing a soil stabilization composition comprising the CO₂ sequestering component, wherein the soil stabilization composition has a δ¹³C value of less than −10‰.

39-42. (canceled)

43. The method according to claim 38, wherein the CO₂ sequestering component is a cementitious component.

44. (canceled)

45. The method according to claim 38, wherein producing the soil stabilization product comprises mixing the CO₂ sequestering component with portland cement, supplementary cementitious material, aggregate, crushed limestone, calcium oxide, calcium hydroxide, natural pozzolans, calcined pozzolans, asphalt emulsion, organic polymeric material, or any combination thereof.

46-47. (canceled)
